(19) United States
(12) Patent Application Publication
(10) Pub. No.: US 2010/0083475 A1
(43) Pub. Date: Apr. 8, 2010

(54) STRIP PACK APPARATUS, AND GRASPER DEVICE AND DEWRINKLER DEVICE USED THEREIN

(75) Inventors: Yoshio Iwasaki, Shiga (JP); Akira Yamamoto, Shiga (JP)

Correspondence Address: GLOBAL IP COUNSELORS, LLP, 1233 20TH STREET, NW, SUITE 700, WASHINGTON, DC, 20036-2680, US

(73) Assignee: ISHIDA CO., LTD., Kyoto (JP)

(21) Appl. No.: 12/447,124

(22) PCT Filed: Oct. 3, 2007
(86) PCT No.: PCT/JP2007/069385

§ 371 Date: Apr. 24, 2009

(30) Foreign Application Priority Data
Oct. 25, 2006 (JP) 2006-289936
Oct. 25, 2006 (JP) 2006-289938
Oct. 25, 2006 (JP) 2006-289939
Oct. 25, 2006 (JP) 2006-289940

(51) Int. Cl. B23Q 1/00

(52) U.S. Cl. 29/283

(57) ABSTRACT

In a strip pack apparatus in which an end portion of a bag being grasped is attached to a tape, a grasper device for grasping the bag holds the end portion from a direction substantially perpendicular to the end portion to be attached to the tape. The grasper device holds the end portion at both sides of an attachment region. In addition, the strip pack apparatus also includes a dewrinkler device for dewrinkling the end portion, and the grasper device grasps the end portion at both sides of the dewrinkler device.

### CROSS-REFERENCE TO RELATED APPLICATIONS

This national phase application claims priority to Japanese Patent Application Nos. 2006-289936, 2006-289938, 2006-289939, and 2006-289940 all filed on Oct. 25, 2006. The entire disclosures of Japanese Patent Application Nos. 2006-289936, 2006-289938, 2006-289939, and 2006-289940 are hereby incorporated herein by reference.

### TECHNICAL FIELD

The present invention is in the technical field of manufacturing products called strip pack, in which a plurality of items is adhered to a backing sheet and displayed in a state of being suspended.

### BACKGROUND ART

As is conventional, products in which a plurality of items, which snacks and the like are filled in a bag, are adhered to a backing sheet in a strip and the like, are known. This kind of a product is displayed in retail stores and so forth in a suspended state with a portion of the backing sheet being held in place, and is referred to as strip pack (meaning a packaging configuration of an item that can be taken by pulling it off) since consumers take each individual item by pulling it off from the backing sheet. This strip pack has an advantage of increasing consumers' eagerness to buy, and can promote diversity in the design and space saving of the display.

A strip pack apparatus for manufacturing this kind of strip pack includes, for example, the apparatus described in Japanese Patent Laid-Open Publication No. 2004-182302, which is arranged directly below a vertical bag-making packaging machine, in which after an item manufactured at the packaging machine is moved by a left and right pair of grasping arms grasping the item at the upper both sides thereof to the adhering position below, the item is adhered to the backing sheet at the upper end portion thereof. In addition, the apparatus described in U.S. Pat. No. 3,864,895 is also arranged directly below a vertical bag-making packaging machine, and after an item manufactured at the packaging machine is grasped and held at the upper single surface thereof by a suction cup and moved to the adhering position in front, the item is adhered to the backing sheet at the upper end portion thereof.

### DISCLOSURE OF THE INVENTION

With a strip pack apparatus like the one described in U.S. Pat. No. 3,864,895, in which the item is grasped and held by a suction cup and moved to the adhering position, it is possible that the item may fall off during the move. And, if the suction power is increased to prevent the falling of the item, it is possible that the release of the item at the adhering position may not be performed smoothly. Consequently, as a means of grasping the item, it is preferable that a grasper device for grasping the item is used, like the strip pack apparatus described in Japanese Patent Laid-Open Publication No. 2004-182302.

However, with the strip pack apparatus described in Japanese Patent Laid-Open Publication No. 2004-182302, since the sides of an item are grasped, if the width of the item changes, it is necessary to move the grasper device in the width direction of the item accordingly, which results in a problem that, in order to do so, the mechanism and operation will become complicated.

Consequently, a first object of the present invention is to enable the process to be done without moving the grasper device that grasps the items, at the time of manufacturing the strip pack in which items are adhered on a backing sheet, even if the width of the items changes.

Meanwhile, if wrinkles are formed on the end portion of the item to be adhered to the backing sheet, not only the appearance of the strip pack is made worse when the item is adhered at the end portion like that, but there is the possibility that a poor bonding occurs with an insufficiency in adhesion, adhesion failure, and the like. Consequently, the dewrinkling of the end portion before adhering the item to the backing sheet is being considered. And, the typical configuration of a dewrinkler device for this purpose is a device that includes a dewrinkling member that undoes the wrinkles on the end portion of the item, and a supporting member that supports this dewrinkling member. The region that this dewrinkling member undoes the wrinkles is the area that is to be adhered to the backing sheet, and the item is being adhered to the backing sheet at this region.

In addition, normally, in the case that an item is held by a grasper device, it is preferable that the end portion of the item to be adhered onto the backing sheet is held. The reason for that is, if the end portion of an item is bent and raised up, and the end portion of the item is being adhered in such condition, the adhesion may fail, or the end portion may be folded to possibly result in a poor bonding, such as an insufficiency in adhesion, or an adhesion failure. For this reason, by grasping the end portion before adhering the item to the backing sheet, the end portion can be flattened back. And, if the end portion is flat, the item can be adhered to the backing sheet in a favorable state, with the end portion and the backing sheet being parallel and overlapped favorably at the time of adhering the item.

Furthermore, in this way, when the end portion of the item on which wrinkles are undone by the dewrinkler device is the same end portion of the item held by the grasper device, it is preferable that the grasper device holds the portion as near the area on which dewrinkling is done by the dewrinkler device as possible. The reason for this is, by holding the area near where dewrinkling is done by the dewrinkler device, the state of this area with wrinkles undone can be kept favorably, and the area with wrinkles undone can be kept flat, and as a result of it, the item can be adhered onto the backing sheet in an excellent state.

However, if the supporting member of the dewrinkler device is positioned on the side of the dewrinkling member, for instance, and sticks out from the area where wrinkles can be undone by the dewrinkling member, the grasper device will interfere with this supporting member, and will not be able to go near the area where dewrinkling is done by the dewrinkler device. As a result, it is difficult for the grasper device to hold the portion near the dewrinkled area. The strip pack will then have an inferior appearance, or a poor adhesion of the item, and the like occurs, due to wrinkles being created again in this dewrinkled area, or the area being bent and raised up and left as it is.

Consequently, a second object of the present invention is to allow the grasper device to be able to reliably grasp the portion near the area dewrinkled by the dewrinkler device, during the manufacturing of the strip pack in which items are adhered to the backing sheet.

The strip pack apparatuses described in the above described the above mentioned publications are directly connected to the vertical bag-making packaging machine arranged immediate above it, and thus, only an item manufactured at this packaging machine can be made into the strip pack. In addition, a quality check on the weight, seal quality, and the like cannot be done before the item manufactured at this packaging machine is made into a strip pack. Consequently, it is desirable to propose a highly versatile strip pack apparatus that is configured to be independent from the devices on the upstream side and downstream side. The basic configuration of this kind of a strip pack apparatus includes a conveying unit for conveying an item generally in the horizontal direction, a moving unit for moving the item conveyed by the conveying unit to an attaching position, and an attaching unit for attaching the item moved by the moving unit to a backing sheet.

In that case, a problem arises of where to arrange the attaching position with respect to the conveying unit. If the attaching position is arranged above the conveying unit, the moving unit will have to move the item up, which is not commonly done. If the attaching position is arranged at the side of the conveying unit, the item will have to be moved to the side, and the width of the strip pack apparatus increases, which deteriorates the layout ability thereof. In that respect, if the attaching position is arranged below the conveying unit, it is only necessary for the moving unit to move the item downward, and in addition, this does not increase the width of the strip pack apparatus. However, a problem occurs when the attaching position is arranged directly below the conveying unit. In order to move the item to the attaching position that is directly below it, it becomes necessary to have a configuration for removing the conveying unit since the conveying unit will be in the way, and so mechanisms and operations for doing so will be complicated, and the speed cannot be increased.

Consequently, the attaching position can be considered to be arranged downward diagonally on the front side in the conveying direction with respect to the conveying unit. By doing so, an item does not have to be moved upward by the moving unit like when the attaching position is arranged above the conveying unit, and in addition, the width of the strip pack apparatus will not increase like when the attaching position is arranged on the side of the conveying unit, and also, mechanisms and operations will not become more complicated for moving an item to the attaching position, like when the attaching position is arranged directly below the conveying unit.

However, if the end portion of an item to be attached to the backing sheet is wrinkled, when attaching the item as it is at the end portion, not only the appearance of the strip pack deteriorates, but possibly a poor attachment, such as an insufficient attachment, an inferior attachment, and the like occurs, and thus, it is contemplated here to undo wrinkles on the end portion before attaching an item to the backing sheet. A dewrinkling unit for this purpose is included in the strip pack apparatus, and the region dewrinkled by this dewrinkling unit is the attachment region to the backing sheet, and the item is attached to the backing sheet at this attachment region.

However, the end portion dewrinkled by this kind of a dewrinkling unit is the end portion on the front side in the conveying direction of the item, and for this reason, if the dewrinkling unit is arranged on the front side in the conveying direction of the conveying unit, this dewrinkling unit interferes with the path in which the item is moved by the moving unit slanting downward on the front side in the conveying direction, and thus, the item cannot be moved slanting downward on the front side in the conveying direction from the conveying unit.

Consequently, a third object of the present invention is to allow an item to be moved smoothly to the attaching position in a highly versatile strip pack apparatus that is independent from devices on the upstream side and downstream side, while including the dewrinkling unit.

In addition, if the position of the items, being conveyed by the conveying unit, on the conveying unit do not stay constant, the position when moving these items to the attaching position also varies every time, and when attaching these items as they are on the backing sheet, the space between the plurality of the items on the backing sheet varies, which the appearance of the strip pack deteriorates. Consequently, before attaching an item to the backing sheet, it is contemplated here to position the item that is conveyed by the conveying unit. A positioning member for this purpose is included in the strip pack apparatus, and items positioned by this positioning member are aligned and attached visually pleasantly on the backing sheet.

However, this kind of a positioning member positions the items by touching the end portions on the front side in the conveying direction of the items, and therefore, if the positioning member is arranged on the front side in the conveying direction of the conveying unit, this positioning member interferes with the path in which the items are moved by the moving unit slanting downward on the front side in the conveying direction, and thus, the items cannot be moved slanting downward on the front side in the conveying direction from the conveying unit.

Consequently, a fourth object of the present invention is to allow items to be moved smoothly to the attaching position in a highly versatile strip pack apparatus that is independent from devices on the upstream side and downstream side, while including the positioning member.

A grasper device according to a first aspect of the present invention for achieving the first object is used in a strip pack apparatus in which an item is attached to a backing sheet at an end portion of the item. The grasper device includes a grasp portion configured and arranged to grasp the end portion of the item to be attached to the backing sheet from a distal end of the end portion of the item.

A grasper device according to a second aspect of the present invention is the grasper device as set forth in the first aspect, wherein the grasp portion is configured and arranged to grasp the end portion on both sides of an attachment region in the end portion to be attached to the backing sheet.

A grasper device according to a third aspect of the present invention is the grasper device as set forth in the first aspect, wherein the grasp portion is configured and arranged to grasp the end portion at both sides of a dewrinkler device of the strip pack apparatus configured and arranged to dewrinkle the end portion of the item.

A grasper device according to a fourth aspect of the present invention is the grasper device as set forth in one of any of the first to the third aspects, wherein the grasp portion is configured and arranged to grasp the end portion of the item with the end portion including a part of a seal portion and a part of a hollow portion, beyond the seal portion, of a bag constituent the item.

A grasper device according to a fifth aspect of the present invention is the grasper device as set forth in one of any of the first to the fourth aspects, wherein the grasp portion is made of elastic material to grasp the end portion.

A strip pack apparatus according to a sixth aspect of the present invention is an apparatus in which an item grasped is attached to a backing sheet at an end portion of the item, wherein the strip pack apparatus comprises the grasper device according to one of any of the first to the fifth aspects, for grasping the item, and an attaching unit configured and arranged to attach the end portion of the item to the backing sheet.

A strip pack apparatus according to a seventh aspect of the present invention is the strip pack apparatus as set forth in the sixth aspect, wherein the strip pack apparatus includes a position detection unit configured and arranged to detect that an item prior to being grasped by the grasper device is in a prescribed position, and a grasp detection unit configured and arranged to detect the item, being detected to be in the prescribed position by the position detection unit, is being grasped by the grasper device.

A strip pack apparatus according to an eighth aspect of the present invention is the strip pack apparatus as set forth in the sixth or the seventh aspects, wherein the strip pack apparatus includes a moving unit configured and arranged to move the item grasped by the grasper device to an attaching position at which the end portion of the item is attached to the backing sheet by the attaching unit.

A dewrinkler device according to a ninth aspect of the present invention for achieving the second object is used in a strip pack apparatus in which an item grasped by a grasper device is attached to a backing sheet at an end portion of the item, wherein the grasper device grasps the same end portion as the end portion on which wrinkles are undone by the dewrinkler device, and the dewrinkler device includes a dewrinkling member configured and arranged to dewrinkle the end portion, and a supporting member supporting the dewrinkling member at an intermediate portion of the dewrinkling member with respect to a direction parallel to the end portion of the item.

A dewrinkler device according to a tenth aspect of the present invention is the dewrinkler device as set forth in the ninth aspect, wherein the dewrinkler device is arranged on both surfaces of the end portion.

A strip pack apparatus according to an eleventh aspect of the present invention is an apparatus in which an item grasped by a grasper device is attached to a backing sheet at an end portion of the item, wherein the strip pack apparatus includes the dewrinkler device according to the ninth or the tenth aspect, for dewrinkling the end portion.

A strip pack apparatus according to a twelfth aspect of the present invention is the strip pack apparatus as set forth in the eleventh aspect, wherein the grasper device is configured and arranged to grasp the end portion of the item along a direction extending substantially parallel to the end portion of the item.

A strip pack apparatus according to a thirteenth aspect of the present invention is the strip pack apparatus as set forth in the eleventh aspect, wherein the grasper device is configured and arranged to grasp the end portion of the item from a distal end of the end portion of the item.

A strip pack apparatus according to a fourteenth aspect of the present invention for achieving the third object is an apparatus for manufacturing a product with a plurality of items attached on a backing sheet, and includes a conveying unit configured and arranged to convey an item generally in the horizontal direction; a dewrinkling unit configured and arranged to dewrinkle an end portion on the front side in the conveying direction of the item conveyed by the conveying unit; a moving unit configured and arranged to move the item, with the end portion dewrinkled by the dewrinkling unit, slanting downward on the front side in the conveying direction; an attaching unit configured and arranged to attach the item moved by the moving unit to a backing sheet at the end portion; and a retracting unit configured and arranged to retract the dewrinkling unit to the front side in the conveying direction when the item is moved by the moving unit.

A strip pack apparatus according to a fifteenth aspect of the present invention is the strip pack apparatus as set forth in the fourteenth aspect, wherein the dewrinkling unit includes an upper dewrinkling member configured and arranged to be positioned above the end portion for dewrinkling the upper surface of the end portion, and a lower dewrinkling member configured and arranged to be positioned below the end portion for dewrinkling the undersurface of the end portion, and the retracting unit is configured and arranged to retract only the lower dewrinkling member.

A strip pack apparatus according to a sixteenth aspect of the present invention is the strip pack apparatus as set forth in the fifteenth aspect, wherein the retracting unit is configured and arranged to move the lower dewrinkling member generally in the horizontal direction so as to retract the lower dewrinkling member towards the front side in the conveying direction.

A strip pack apparatus according to a seventeenth aspect of the present invention is the strip pack apparatus as set forth in the fifteenth aspect, wherein the retracting unit is configured and arranged to turn the lower dewrinkling member downwardly so as to retract the lower dewrinkling member to the front side in the conveying direction.

A strip pack apparatus according to an eighteenth aspect of the present invention is the strip pack apparatus as set forth in the sixteenth aspect, wherein the upper dewrinkling member and the lower dewrinkling member are an upper brush and a lower brush for rotating from the base portion side to the edge portion side of the end portion of the item while in contact with the upper surface and the undersurface of the end portion, and the dewrinkling unit includes a drive roller driven by a driving source to rotate the upper brush, and a driven roller driven by being in contact with this drive roller for rotating the lower brush. When the lower brush is moved generally in the horizontal direction by the retracting unit, the driven roller is separated from the drive roller.

A strip pack apparatus according to a nineteenth aspect of the present invention is the strip pack apparatus as set forth in the eighteenth aspect, wherein the drive roller is made of metal, and the driven roller is made of resin.

The strip pack apparatus, for manufacturing a product with a plurality of items attached to a backing sheet, according to a twentieth aspect of the present invention for achieving the fourth object includes a conveying unit configured and arranged to convey an item generally in the horizontal direction, a positioning unit configured and arranged to position the item by being in contact with the end portion on the front side in the conveying direction of the item conveyed by the conveying unit, a moving unit configured and arranged to move the item positioned by the positioning member slanting downward on the front side in the conveying direction, an attaching unit configured and arranged to attach the item moved by the moving unit to a backing sheet at the end portion, and a retracting unit configured and arranged to retract the positioning unit generally towards the front side in the conveying direction when the item is moved by the moving unit.

The strip pack apparatus according to a twenty first aspect of the present invention is the strip pack apparatus as set forth in the twentieth aspect, wherein the strip pack apparatus includes a dewrinkling unit configured and arranged to dewrinkle an end portion on the front side in the conveying direction of the item positioned by the positioning unit, and the retracting unit is further configured and arranged to retract the dewrinkling unit generally towards the front side in the conveying direction when the item is moved by the moving unit.

The strip pack apparatus according to a twenty second aspect of the present invention is the strip pack apparatus as set forth in the twenty first aspect, wherein the dewrinkling unit includes an upper dewrinkling member configured and arranged to be positioned above the end portion for dewrinkling the upper surface of the end portion, and a lower dewrinkling member configured and arranged to be positioned below the end portion for dewrinkling the undersurface of the end portion. The positioning unit is coupled to the lower dewrinkling member. The retracting unit configured and arranged to retract the lower dewrinkling member and the positioning member.

With the grasper device according to the first aspect of the present invention, the grasper device used for holding an item in a strip pack apparatus does not hold the side portions of the item, but holds the end portion from the side of the end portion of the item to be attached to the backing sheet. For this reason, for example, if the grasper device is arranged in the center portion in the width direction of the item, the grasper device does not have to be moved for any items with any kind of a width, and the grasper device is able to always hold the end portions of the items reliably, and as a result, there will not be a problem of the mechanisms and operations for moving the grasper device being complicated. Furthermore, by holding the end portion of an item to be attached to the backing sheet, there is also the advantage of, for example, the end portion able to be flattened even if the end portion is bent, and thus, items can be attached to the backing sheet in a favorable state.

With the grasper device according to the second aspect of the present invention, the grasper device holds the end portion at the both sides of the attachment region provided on the end portion, and therefore, the attachment region of the end portion that is actually to be attached to the backing sheet can be flattened effectively, and as a result, this further improves the way the items are attached.

With the grasper device according to the third aspect of the present invention, since the grasper device holds the end portion at the both sides of the dewrinkler device for undoing wrinkles on the end portion, the region of the end portion dewrinkled by the dewrinkler device can be flattened efficiently, and this also further improves the way the items are attached.

With the grasper device according to the fourth aspect of the present invention, since the grasper device holds the seal portion of the packaged item having the hollow portion and the seal portion, and also holds all the way to a portion of the hollow portion, beyond the seal portion, for example, even if the contents filled in the hollow portion is forced to the side of the seal portion due to the motion inertia and the like, the seal portion is prevented from being looped back or bent due to this pressure.

With the grasper device according to the fifth aspect of the present invention, since the grasper device holds the end portion with grasp portions that are highly elastic, for example, if the shape of the grasp portions are in a shape to allow them to gradually hold the end portion from the edge portion side to the base portion side, the end portion will not be wrinkled easily while being held, and the portion is held firmly when the holding thereof is completed.

With the strip pack apparatus according to the sixth aspect of the present invention, the strip pack apparatus includes the grasper device according to one of any of the first to the fifth aspects for holding the items, and therefore, a strip pack apparatus having the same effects as the first to the fifth aspects can be obtained.

With the strip pack apparatus according to the seventh aspect of the present invention, the strip pack apparatus detects that an item is in a proper position before it is held by the grasper device, and detects that the item detected to be in a proper position is held by the grasper device. Therefore, by attaching only the items that pass both detections to the backing sheet, a strip pack with a plurality of items aligned visually pleasantly on the backing sheet is reliably manufactured.

With the strip pack apparatus according to the eighth aspect of the present invention, since the strip pack apparatus moves the item held by the grasper device to the attaching position, the position where an item is grasped (grasp position) and the position where the grasped item is attached to the backing sheet (attaching position) can be separated, and the attachment operation can be performed well having a plenty of space at the attaching position.

With the dewrinkler device according to the ninth aspect of the present invention, since the dewrinkler device used for undoing wrinkles on the end portion of an item in a strip pack apparatus includes a dewrinkling member for undoing wrinkles on the end portion, and a supporting member for supporting the dewrinkling member at the intermediate portion of this dewrinkling member, the supporting member is not positioned at the side of the dewrinkling member, and therefore, the supporting member does not stick out from the region on which wrinkles can be undone by the dewrinkling member. As a result, the grasper device for holding the same end portion does not interfere with the supporting member, and is able to reliably hold portions near the region dewrinkled by the dewrinkler device. As a result, the dewrinkled state of this region can be kept well, and also, the dewrinkled region can be kept flat, and so items can be attached to the backing sheet in an excellent state.

With the dewrinkler device according to the tenth aspect of the present invention, since the dewrinkling member of the dewrinkler device undoes wrinkles from both surfaces of the end portion, dewrinkling of the end portion can be done efficiently and sufficiently.

With the strip pack apparatus according to the eleventh aspect of the present invention, since the strip pack apparatus includes the dewrinkler device according to the ninth or the tenth aspect for undoing wrinkles on the end portions of the items, a strip pack apparatus having the same effects as the ninth or the tenth aspect can be obtained.

With the strip pack apparatus according to the twelfth aspect of the present invention, since the grasper device of the strip pack apparatus holds an end portion from the sides of the item, the grasper device is able to hold the item from the sides of the item near the region dewrinkled by the dewrinkler device.

With the strip pack apparatus according to the thirteenth aspect of the present invention, since the grasper device of the strip pack apparatus holds the end portion from the side of the end portion, in a different embodiment, the grasper device is able to hold the item from the front and rear direction, near the area dewrinkled by the dewrinkler device.

With the strip pack apparatus according to the fourteenth aspect of the present invention, in the case that the dewrinkling unit undoes wrinkles on the end portion on the front side in the conveying direction of the item, and the moving unit moves the item slanting downward on the front side in the conveying direction, the strip pack apparatus retracts the dewrinkling unit to the front side in the conveying direction when the moving unit moves the item, and for this reason, even if structurally the dewrinkling unit and the path in which the moving unit moves the item slanting downward on the front side in the conveying direction interferes with each other, the item is moved smoothly to the attaching position.

With the strip pack apparatus according to the fifteenth aspect of the present invention, in the case that the dewrinkling unit separately includes an upper dewrinkling member that is above and a lower dewrinkling member that is below the end portion of the item, since only the lower dewrinkling member with which the end portion of the item interferes is retracted, the item is allowed to be moved to the attaching position efficiently and sufficiently, with a minimum necessary operation.

With the strip pack apparatus according to the sixteenth aspect of the present invention, since the lower dewrinkling member is retracted to the front side in the conveying direction by being moved roughly horizontally, the item is allowed to be moved to the attaching position with a simple operation.

With the strip pack apparatus according to the seventeenth aspect of the present invention, in a different embodiment, since the lower dewrinkling member is retracted to the front side in the conveying direction by being turned downwardly, in this case also, the item is allowed to be moved to the attaching position with a simple operation.

With the strip pack apparatus according to the eighteenth aspect of the present invention, since simultaneously with the retracting of the lower brush, which is the lower dewrinkling member, to the front side in the conveying direction by moving the lower brush roughly horizontally, the driven roller separates from the drive roller and the driven roller is not being driven, and the rotation of the lower brush being retracted stops, even if the end portion of the item at the time of being moved slanting downwardly is mistakenly touched by the lower brush, an awkward dewrinkling force does not act on this end portion, and this avoids a problem of the dewrinkled end portion being wrinkled again.

With the strip pack apparatus according to the nineteenth aspect of the present invention, by having the drive roller made of metal and the driven roller made of resin, in other words, by having the roller that will not be retracted and is stationary made of metal, which is hard, and by having the roller that is movable and to be retracted made of resin, which is soft, the contacting force between the rollers improves, and the power between the rollers is transferred well.

With the strip pack apparatus according to the twentieth aspect of the present invention, in the case that the positioning member positions the item by touching the end portion on the front side in the conveying direction of the item, and that the moving unit moves the item slanting downward on the front side in the conveying direction, the strip pack apparatus retracts the positioning member to the front side in the conveying direction when the moving unit moves the item, and thus, even if structurally the positioning member and the path in which the item is moved by the moving unit slanting downwardly on the front side in the conveying direction interfere with each other, the item is moved smoothly to the attaching position.

With the strip pack apparatus according to the twenty first aspect of the present invention, in the case that the strip pack apparatus further includes a dewrinkling unit for undoing wrinkles on the end portion on the front side in the conveying direction of the item with which the positioning member is in contact, since the dewrinkling unit is also retracted to the front side in the conveying direction when the item is moved by the moving unit, even if structurally the dewrinkling unit and the path in which the item is moved by the moving unit slanting downwardly to the front side in the conveying direction interfere with each other, the item still will be moved smoothly to the attaching position.

With the strip pack apparatus according to the twenty second aspect of the present invention, in the case that the dewrinkling unit separately includes an upper dewrinkling member that is above, and a lower dewrinkling member that is below the end portion of the item, since only the lower dewrinkling member with which the end portion of the item interferes is retracted, the item is allowed to be moved to the attaching position efficiently and sufficiently, with a minimum necessary operation. In addition, in the case that the positioning member is included in the lower dewrinkling member, the retracting unit for retracting the positioning member is used also as the means for retracting the lower dewrinkling member. As a result, the positioning member and the lower dewrinkling member can both be retracted at once, and the item is allowed to be moved to the attaching position even more efficiently and sufficiently, with a minimum necessary operation.

The objects, characteristics, aspects, and advantages of this invention will become even more clear with the detailed description below and the attached drawings.

### BRIEF DESCRIPTION OF THE DRAWINGS

FIG. 1 is a perspective view showing a strip pack apparatus according to an embodiment of the present invention;

FIG. 2 is a side view showing the strip pack apparatus;

FIG. 3(a) is a plan view showing a bag to be supplied to the strip pack apparatus, and FIG. 3(b) is a plan view showing a strip pack manufactured by the strip pack apparatus;

FIG. 4 is a side view showing the positional relationship between a grasp position and an attaching position in the strip pack apparatus;

FIG. 5 is a side view showing an attaching unit of the strip pack apparatus;

FIG. 6 is plan view showing the state when a bag is attached to a tape by the attaching unit;

FIG. 7 is a plan view showing the state when dewrinkling a seal portion of a bag by a brush unit, and the state of the seal portion being held by a grasp unit in the strip pack apparatus;

FIG. 8 is a perspective view of the brush unit of the strip pack apparatus;

FIG. 9 is a side view of the brush unit of the strip pack apparatus;

FIG. 10 is a cross-sectional side view showing the contacting relationship between a drive roller and a driven roller of the brush unit of the strip pack apparatus;

FIG. 11 is a side view showing the grasp unit of the strip pack apparatus;

FIG. 12(a) is a side view showing the start of the holding of the seal portion of a bag by the grasp unit of the strip pack apparatus, FIG. 12(b) is a side view showing the end of the holding of the seal portion of a bag by the grasp unit, and FIG. 12(c) is a side view showing after the seal portion of a bag is held by the grasp unit;

FIG. 13 is a side view showing the positional relationship between the grasp position and the attaching position in the strip pack apparatus;

FIG. 14 is a side view showing the attaching unit of the strip pack apparatus;

FIG. 15 is a block diagram showing the control system of the strip pack apparatus;

FIG. 16 is a flowchart showing the control flow of the operations of the strip pack apparatus;

FIG. 17 is a plan view showing a modification example of the grasp unit of the strip pack apparatus;

FIG. 18 is a plan view showing a modification example of the grasp unit of the strip pack apparatus;

FIG. 19 is a plan view showing a modification example of the grasp unit of the strip pack apparatus;

FIG. 20 is a side view showing the state of a lower brush of the brush unit being retracted;

FIG. 21 is a flowchart showing the control flow of the operations of the strip pack apparatus;

FIG. 22 is a side view showing a modification example when a lower brush of the brush unit is to be retracted;

FIG. 23 shows a positioning member of the strip pack apparatus;

FIG. 24 is a side view showing the brush unit of the strip pack apparatus; and

FIG. 25 is a side view showing the state of the positioning member being retracted.

### BEST MODE FOR CARRYING OUT THE INVENTION

### A. Strip Pack Apparatus 1

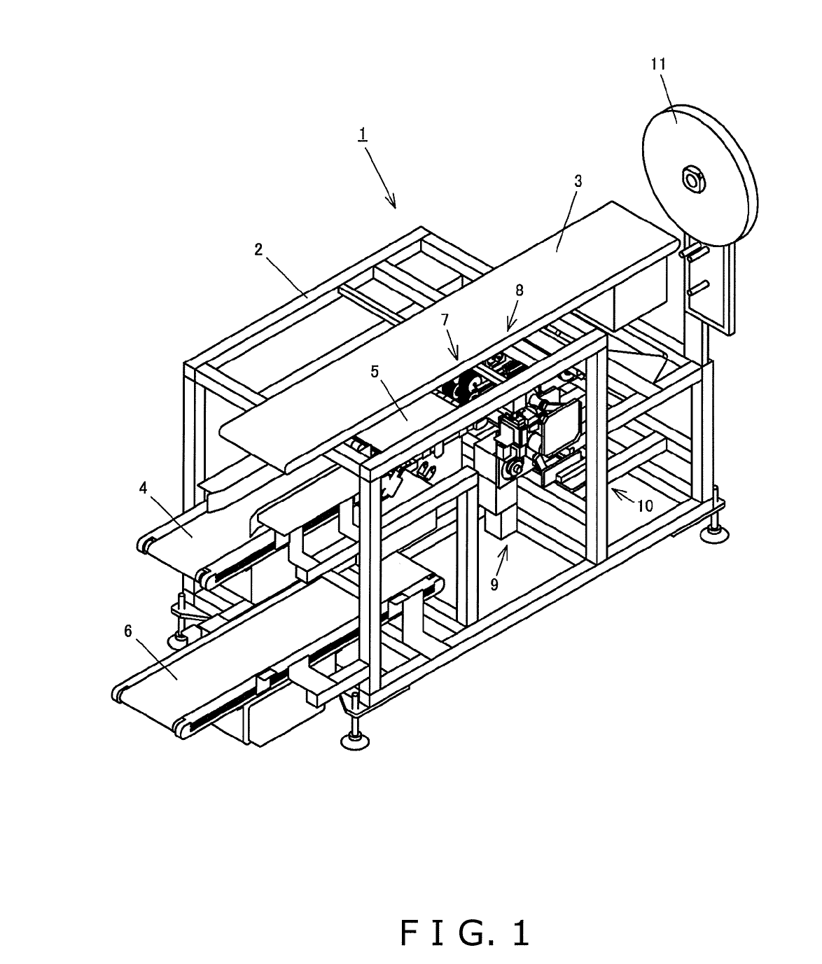

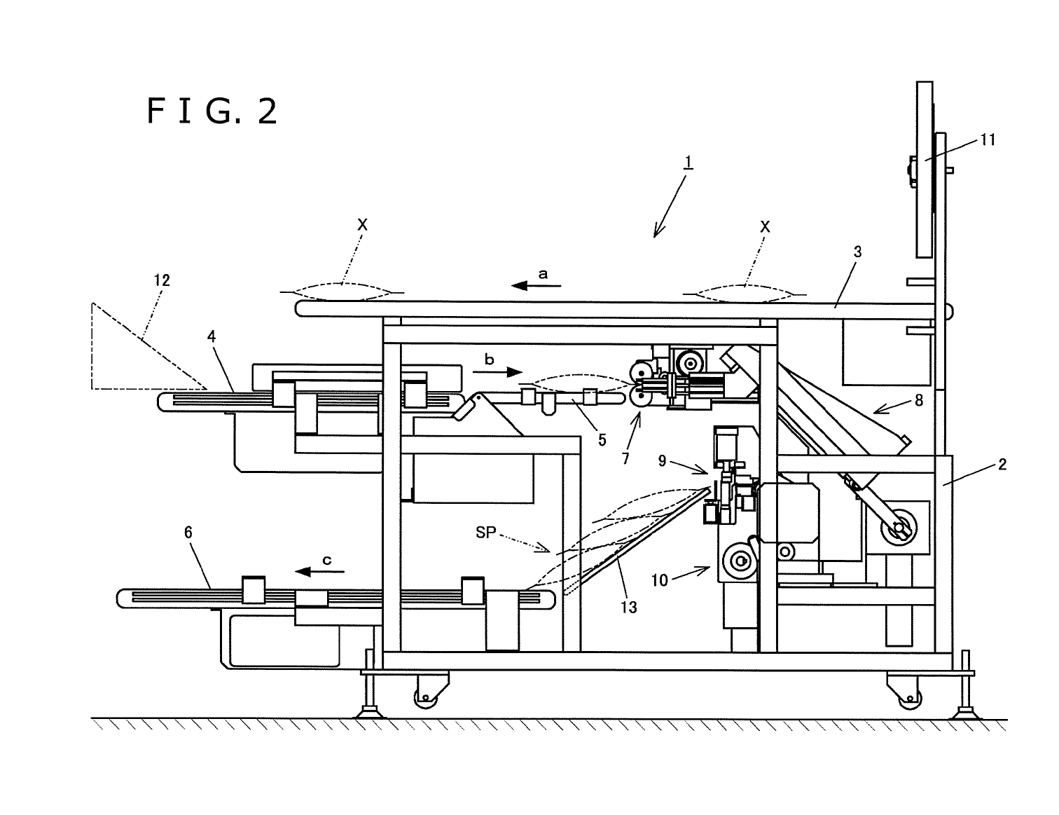

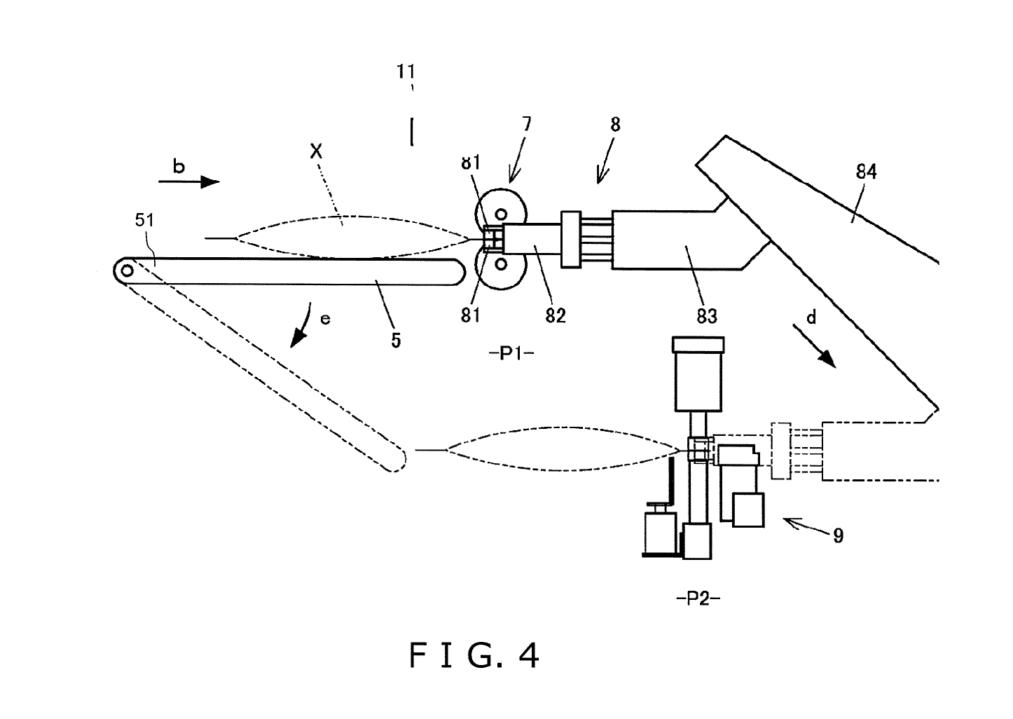

FIGS. 1 and 2 show a perspective view and a side elevation respectively, conceptually showing a strip pack apparatus 1 according to an embodiment of the present invention. FIG. 4 shows the flow of a series of processes, from a process of guiding a packaged item (bag X) to the interior of the strip pack apparatus 1, to a process of attaching the packaged item to a tape T.

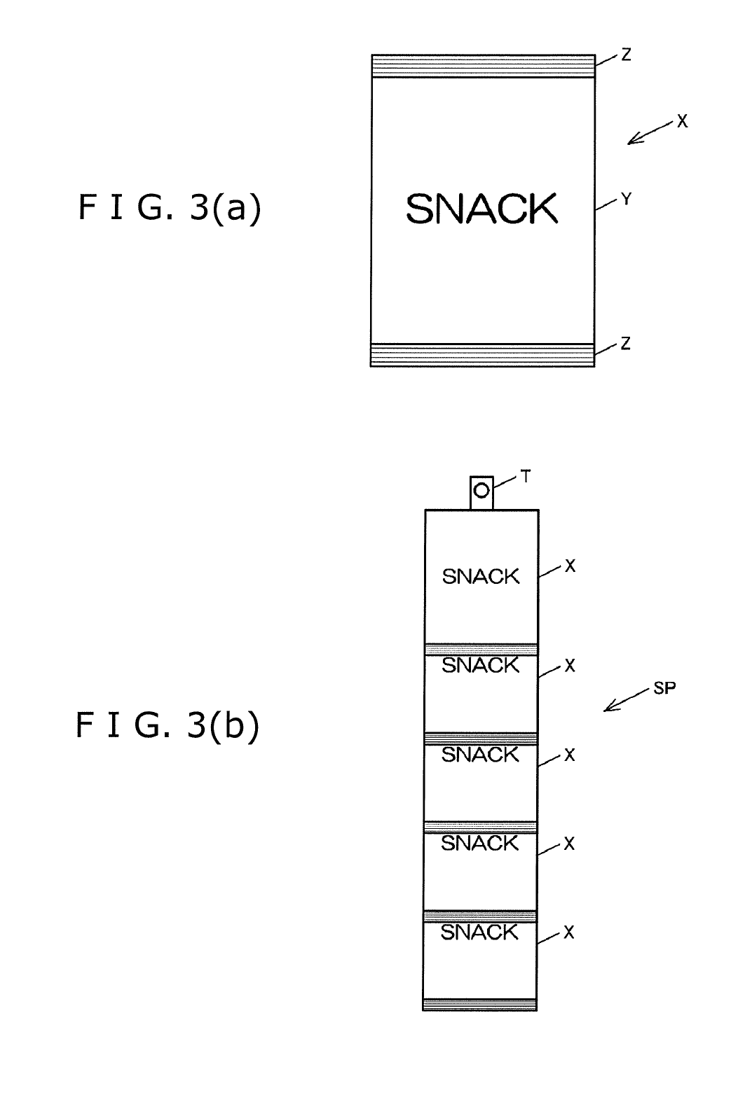

FIGS. 3(a) and 3(b) show the packaged item (bag X) and a strip pack SP, respectively. Bag X has a hollow portion Y in which snacks and the like are filled, and two top and bottom seal portions Z (FIG. 3(a)). In addition, the top seal portion Z refers to the side of the seal portion Z on which the letters “SNACK” written on the bag can be read from a normal viewpoint, when one of the two seal portions Z is picked and lifted up.

In the strip pack SP, a predetermined number of bags X are aligned and attached on the tape T (FIG. 3(b)). The top seal portions Z of the bags X are attached to the tape T. A hole punched is provided on a portion near an end of the tape T for allowing the strip pack SP to be displayed suspended.

### Brief Overview of the Strip Pack Apparatus 1

The strip pack apparatus 1 having great versatility is an apparatus for manufacturing strip packs SP, and is independent from both the devices on the upstream and downstream sides. Furthermore, a packaging unit and the like for charging articles into the bags X through automatic packaging are included in the device on the upstream side. A device and the like for putting the strip packs SP into a box are included in the device on the downstream side.

Specifically, the strip pack apparatus 1 includes a body unit 2, a supply conveyor 3, a lead-in conveyor 4, a drop conveyor 5, a discharge conveyor 6, a brush unit 7, a grasp unit 8, an attaching unit 9, and a tape feeding unit 10.

The supply conveyor 3, the lead-in conveyor 4, the drop conveyor 5, the discharge conveyor 6, the brush unit 7, the grasp unit 8, the attaching unit 9, and the tape feeding unit 10 are supported by the body unit 2.

Each device will be described in detail below.

### Supply Conveyor 3

The supply conveyor 3 supplies the bags X produced at the device on the upstream side to the strip pack apparatus 1. More specifically, the supply conveyor 3 is arranged outside the strip pack apparatus 1, and conveys the bags X in the direction roughly horizontal, and in the direction of arrow a (FIG. 2).

### Lead-In Conveyor 4

The lead-in conveyor 4 guides the bags X supplied by the supply conveyor 3 to the interior of the strip pack apparatus 1. More specifically, the lead-in conveyor 4 conveys the bags X in a direction roughly horizontal, and in the direction of arrow b (FIG. 2). At this time, the bags X are conveyed in the direction of arrow b with the top seal portions Z to the front. In addition, the arrow b direction is the opposite direction from the arrow a direction.

A member 12 is arranged on the starting end portion side of the lead-in conveyor 4 that conveys the bags X in the arrow b direction (FIG. 2). The member 12 prevents the bags X, dropped from the supply conveyor 3, from not being entered into the strip pack apparatus 1. Furthermore, the member 12 is omitted in FIG. 1.

### Drop Conveyor 5

The drop conveyor 5 is positioned on the terminal end portion side of the lead-in conveyor 4, and guides the bags X conveyed by the lead-in conveyor 4 to the brush unit 7.

As shown in FIG. 4, the drop conveyor 5 can move in the arrow e direction with a fulcrum 51 as the center thereof. The drop conveyor 5 tilts with the movement thereof in the arrow e direction.

The movement of the drop conveyor 5 is linked to the movement of the grasp unit 8. This is described in detail in “C. Grasp Unit 8”.

### Brush Unit 7

The brush unit 7 is a device for undoing the wrinkles on the top seal portions Z of the bags X being conveyed thereto by the drop conveyor 5, and can be comprehended to be a dewrinkler device. In addition, this is described in detail in “B. Brush Unit 7”.

### Grasp Unit 8

The grasp unit 8 is a device for grasping the top seal portions Z of the bags X dewrinkled by the brush unit 7, and can be comprehended to be a grasper device. In addition, this is described in detail in “C. Grasp Unit 8”.

### Retracting Cylinder 70

A retracting cylinder 70 is a device for retracting the brush unit (dewrinkler device) 7, and can be comprehended to be a retracting unit. In addition, this is described in detail in “D. Retracting cylinder 70”.

### Positioning Member 130

A positioning member 130 is a member for determining the position of the seal portions Z where wrinkles will be undone by the brush unit 7, and can be comprehended to be a positioning member. In addition, this is described in detail in “E. Positioning Member 130”.

### Attaching Unit 9

### Structure of Attaching Unit 9

The attaching unit 9 attaches the top seal portions Z of the bags X grasped by the grasp unit 8 to the tape T. The strip pack SP manufactured by a predetermined number of bags X being attached is being received at the tilted receiver 13, and guided to the discharge conveyor 6 (FIG. 2). Note that the receiver 13 is omitted in FIG. 1.

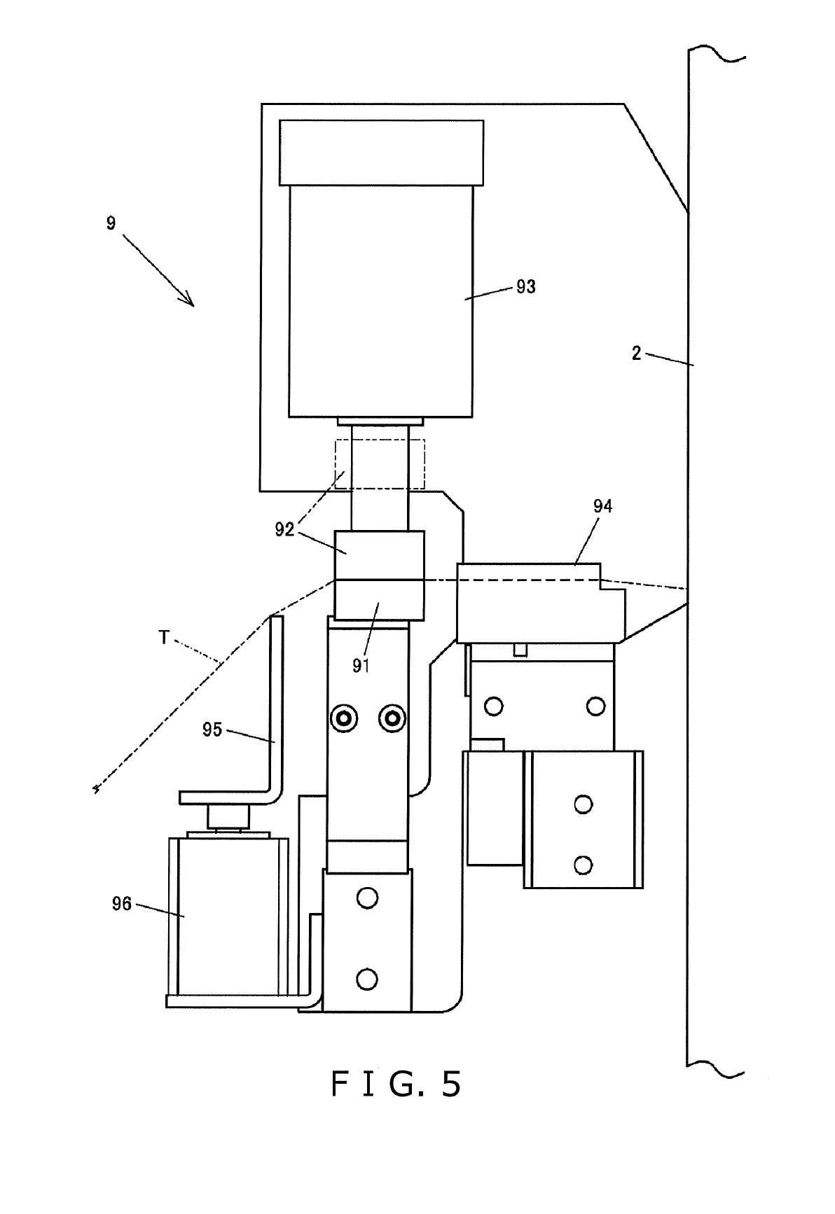

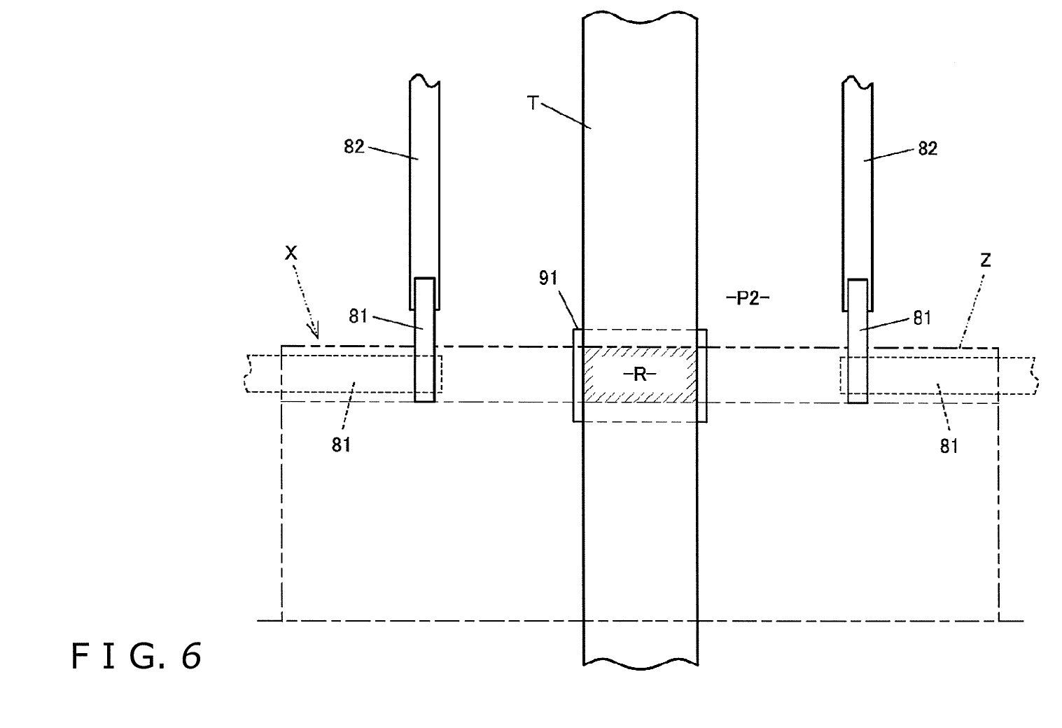

Details will be described using FIGS. 5 and 6. FIG. 5 is a diagram of the attaching unit 9 seen from the side, and FIG. 6 is a diagram of the attaching unit 9 seen from above.

The attaching unit 9 includes a heater 91, a clamp 92, a clamp air cylinder 93, a punch/cutter unit 94, a melting prevention member 95, and an air cylinder 96. The heater 91 is the source of heat used for adhering the bags X and the tape T.

The clamp 92, capable of moving up and down, sandwiches the bags X and the tape T together with the heater 91, and is able to press the bags X against the tape T. The up and down movement of the clamp 92 is executed by the clamp air cylinder 93.

The punch/cutter unit 94 can properly punch holes and put perforations on the tape T.

The melting prevention member 95 prevents the tape T from being melted by raising the tape T up from the heater 91, with the upward movement thereof. The up and down movement of the melting prevention member 95 is executed by the air cylinder 96.

### Operation of Attaching Unit 9

The operation of the attaching unit 9 will now be described. First, in the state of the clamp 92 being moved to the top, tape T paid out from a roll 11 is placed on top of the heater 91. The top seal portion Z of the bag X moved to the position P2 by the grasp unit 8 is being overlapped with the tape T on top of the heater 91.

The tape T and the seal portion Z are sandwiched by the downward movement of the clamp 92, and the seal portion Z is being pressed against the tape T. By doing so, the seal portion Z adheres to the tape T with the heat from the heater 91. Furthermore, the region of the seal portion Z being adhered to the tape T is shown by the symbol R in FIG. 6.

The attaching unit 9 repeats the adhering of the bags X, and attaches a plurality of bags X on this strip of tape T along the longitudinal direction thereof.

### Discharge Conveyor 6

The discharge conveyor 6 discharges the strip packs SP manufactured at the strip pack apparatus 1 to a device on the downstream side. More specifically, the discharge conveyor 6 conveys the strip packs SP to the arrow c direction (FIG. 2).

### Tape Feeding Unit 10

The tape feeding unit 10 pays out the tape T from the roll 11 in synchronism with the manufacturing of the strip pack SP. In addition, the roll 11 is arranged on the upper side of the body unit 2, and can be exchanged.

### Modification Example

Although the strip pack apparatus 1 described above is independent from both the devices on the upstream and downstream sides, it may be, for example, combined with the device on the upstream side or the device on the downstream side thereof.

### B. Brush Unit 7

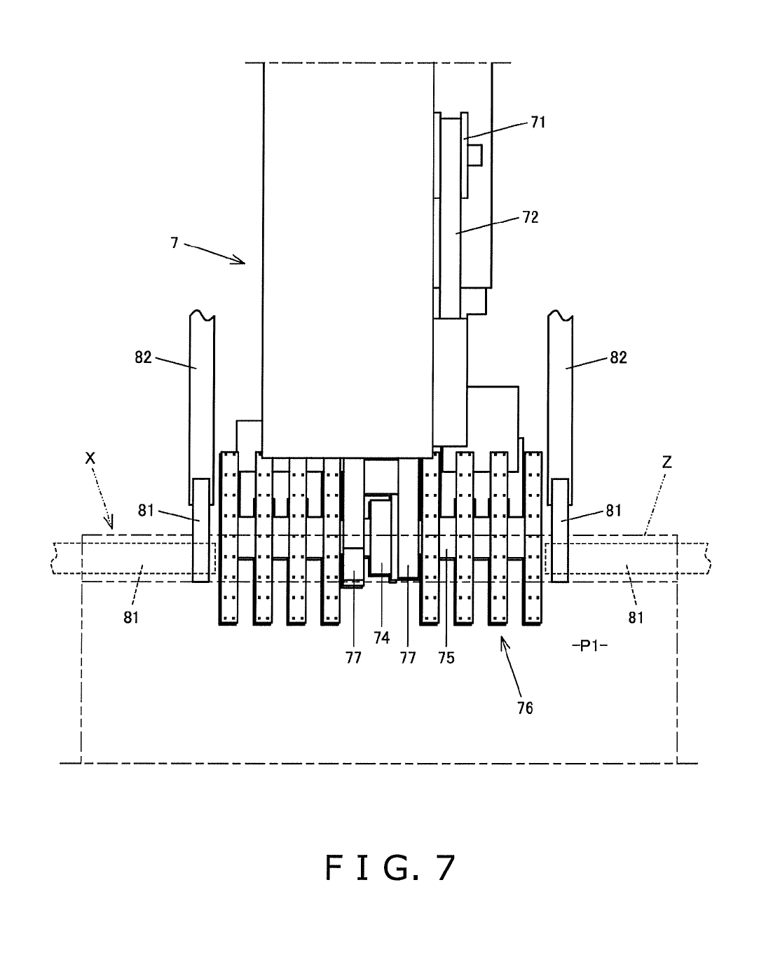

FIGS. 7 to 9 are top view, perspective view, and side view showing the brush unit (dewrinkler device) 7 included in the strip pack apparatus 1 in accordance with this embodiment.

The brush unit 7 is arranged on the distant side of the arrow b with respect to the drop conveyor 5 (FIG. 4), and undoes the wrinkles on the seal portions Z of the bags X. The configuration of the brush unit 7 will be described below using FIGS. 7 to 9.

### Configuration Of Brush Unit 7

Specifically, the brush unit 7 includes a drive pulley 71, a timing belt 72, a driven pulley 73, a drive roller 78, and a driven roller 79, and further includes two of each of the shaft pulleys 74, rotation shafts 75, brushes 76, and supporting members 77. Note that the supporting members 77 will be described later.

The drive pulley 71 is driven to rotate by a motor, for instance. The timing belt 72 is looped over the drive pulley 71 and the driven pulley 73. Consequently, the rotation of the drive pulley 71 is transferred to the driven pulley 73 through the timing belt 72.

The drive roller 78, integral with the driven roller 73, rotates in the same direction as the direction that the driven roller 73 rotates. That is, the rotation of the drive pulley 71 is being transferred as it is through the timing belt 72 and the driven roller 73.

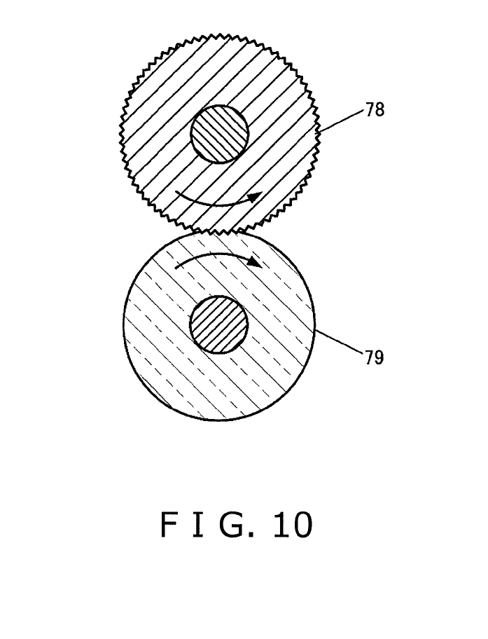

The driven roller 79 is in contact with the drive roller 78, and the rotation of the drive roller 78 is being transferred directly. Furthermore, it is preferable to use metal as the material for the drive roller 78 and resin as the material for the driven roller 79, from the standpoint of efficiently transferring the power (rotation) from the drive roller 78 to the driven roller 79. It is further preferable to have the surface of the drive roller 78 knurled, as shown in FIG. 10.

The shaft pulleys 74 are arranged one on the upper side and one on the lower side. The rotation of the driven pulley 73 is transferred to the upper shaft pulley 74 via the timing belt. The rotation of the driven roller 79 is transferred to the lower shaft pulley 74 via the timing belt.

The brushes 76 are arranged one on the upper side and one on the lower side, and able to sandwich the seal portions Z of bags X from the upper side and the lower side. With both the upper and the lower brushes 76, a plurality of thin disk-shaped separated brushes is arranged side by side on the rotation shafts 75 at predetermined intervals. In addition, spongious brushes (rollers), brushes like scrubbing brushes with wire rods tied together radially, and the like, can be adopted for the brushes 76.

The upper rotation shaft 75 with the brush 76 provided couples with the upper shaft pulley 74, and rotates in the same direction as the direction that the upper shaft pulley 74 rotates. The lower rotation shaft 75 with the brush 76 provided couples with the lower shaft pulley 74, and rotates in the same direction as the direction that the lower shaft pulley 74 rotates.

Consequently, by rotating the drive pulley 71, the upper brush 76 rotates in the same direction as the direction that the drive pulley 71 rotates, and the lower brush 76 rotates in the opposite direction from the direction that the drive pulley 71 rotates.

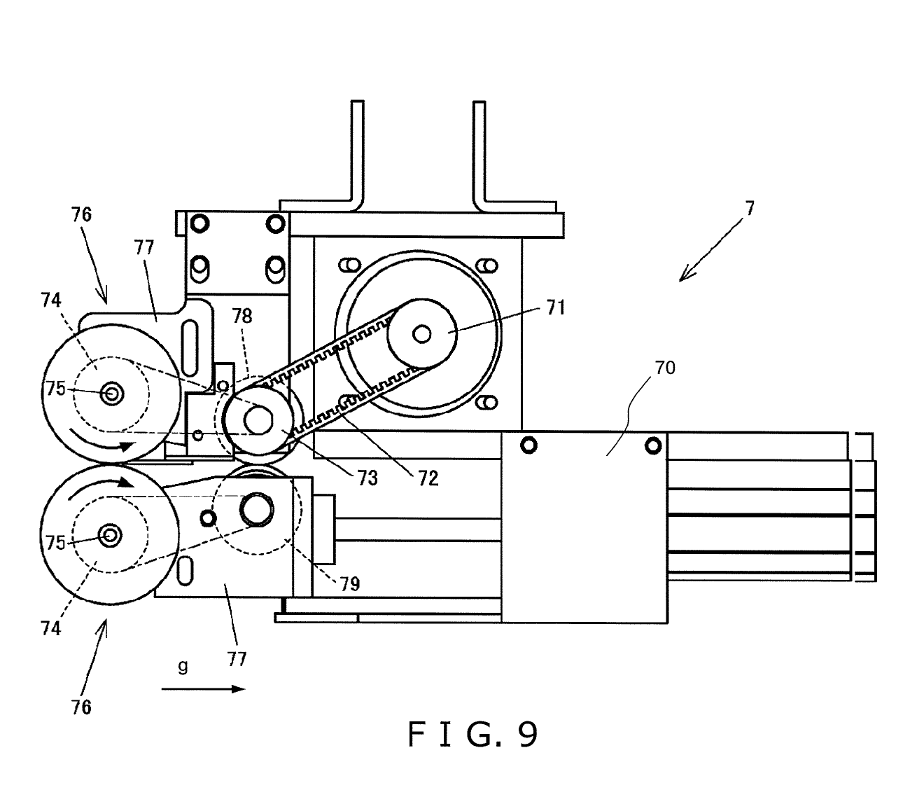

According to the brush unit described above, by rotating the drive pulley 71 in the counterclockwise direction shown in FIG. 9, in the state that the upper and lower brushes 76 sandwich the seal portion Z, the upper and lower brushes 76 can be rotated in the following manner. That is, the upper brush 76 rotates from the base portion side to the edge portion side of the seal portion Z, in the state of being in contact with the upper surface of the seal portion Z. The lower brush 76 rotates from the base portion side to the edge portion side of the seal portion Z, in the state of being in contact with the undersurface of the seal portion Z.

Consequently, wrinkles on the seal portion Z are undone by being stroked by the two upper and lower brushes 76. Moreover, the seal portion Z can be dewrinkled efficiently and sufficiently, since the wrinkles are undone by the seal portion Z being sandwiched from above and below. In addition, the brushes 76 can be comprehended to be the dewrinkling members, in view of the dewrinkling being done by the brushes 76.

### Supporting Members 77

The supporting members 77 are arranged one on the upper side and one on the lower side (FIG. 9). The upper supporting member 77 supports the driven pulley 73, the drive roller 78, the upper shaft pulley 74, the upper rotation shaft 75, and the upper brush 76. The lower supporting member 77 supports the driven roller 79, the lower shaft pulley 74, the lower rotation shaft 75, and the lower brush 76.

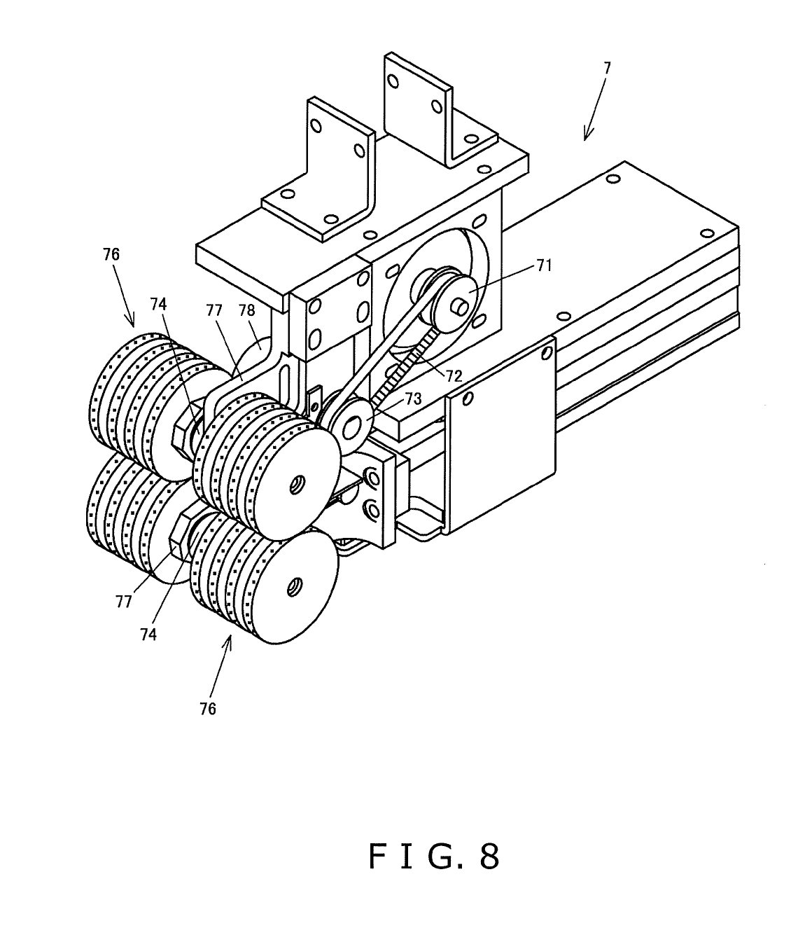

Both the upper and the lower supporting members 77 are positioned in the center of the brushes 76 in the width direction of the brushes 76 (FIGS. 7 and 8). For this reason, different from if the supporting members 77 are provided lateral to the brushes 76, the supporting members 77 will not interfere with a grip fingers 81 of the grasp unit 8 to be described later even if the grip fingers 81 come near the brushes 76. This is because the supporting members 77 do not stick out from the region on which the wrinkles are undone by the brushes 76. Consequently, the seal portions Z of the bags X can be grasped at a position near the brushes 76.

By grasping the seal portions Z at a position near the brushes 76, dewrinkling becomes easy through the brush unit 7. That is, the dewrinkled part of the seal portions Z become flat, and the attachment of the seal portions Z to the tape T through the attaching unit 9 becomes easy (FIG. 6).

### C. Grasp Unit 8

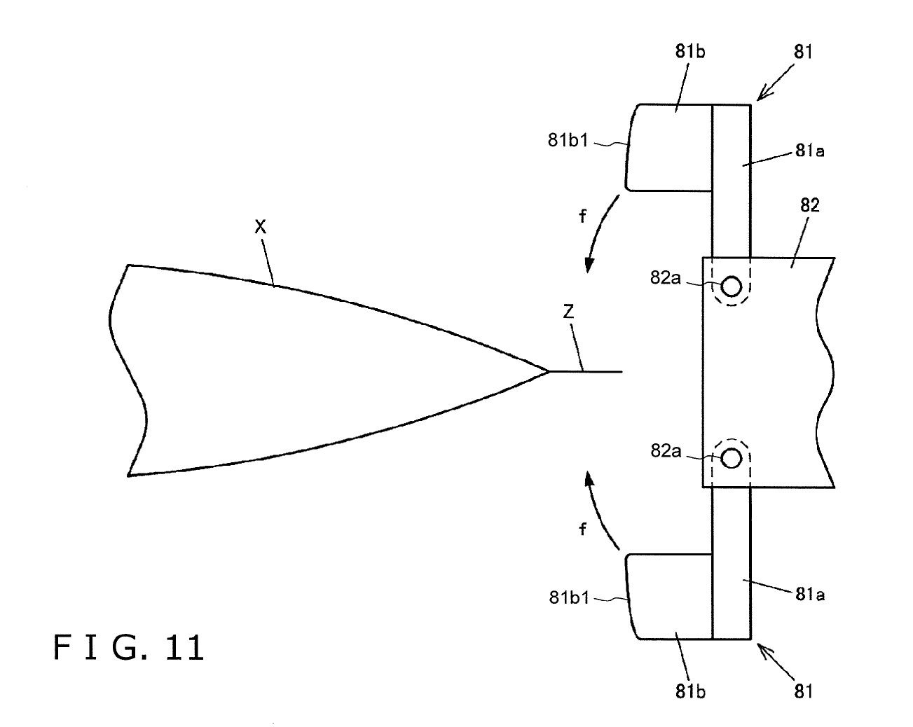

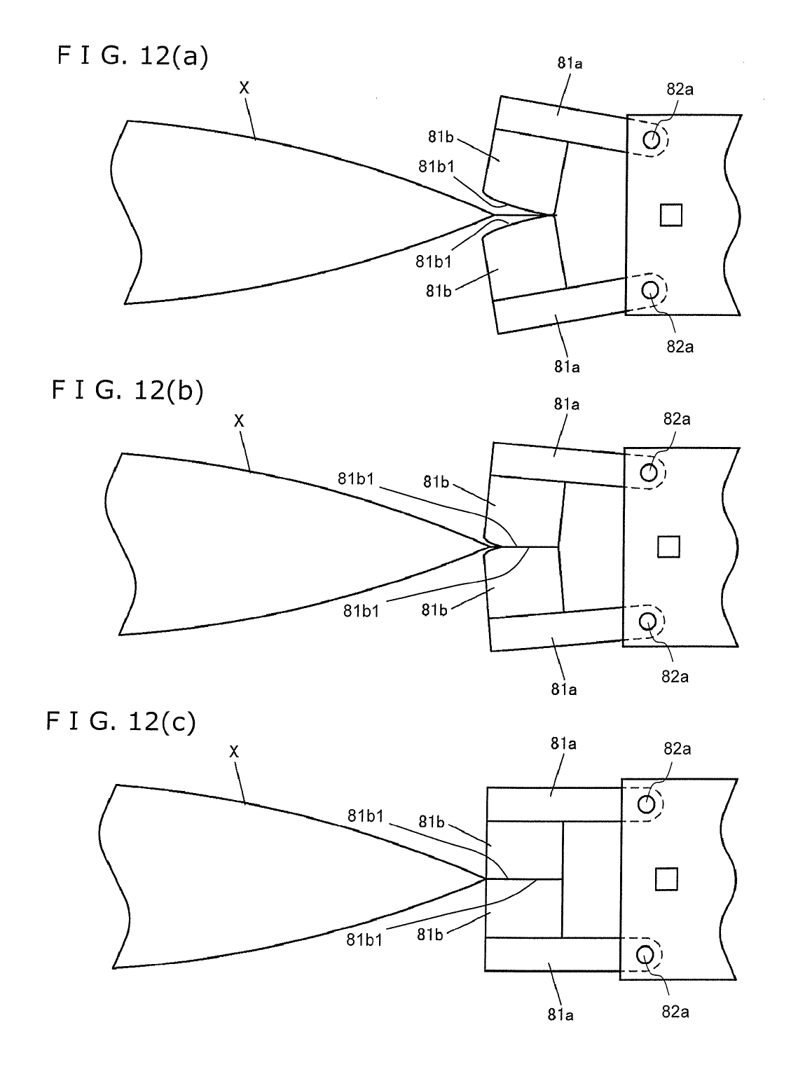

FIG. 11 is a diagram of the grasp unit (grasper device) 8 viewed from the side. FIGS. 12(a) to 12(c) show the operation of the grasp unit 8 in sequence. The configuration and operation of the grasp unit 8, and the positional relationship thereof with the brush unit 7 will be described below using FIGS. 11, 12, and 4. In addition, the control of the grasp unit 8 will be described later.

### Configuration of Grasp Unit 8

The grasp unit 8 grasps the upper seal portions Z of the bags X dewrinkled by the brush unit 7 from a distal end of the upper seal portion Z (distant side of arrow b) with respect to the bags X. More specifically, the grasp unit 8 is arranged on the distant side of the arrow b from the drop conveyor 5, and includes the pair of grip fingers 81, hands 82, arms 83, and guide rails 84 (FIG. 4).

The pair of grip fingers 81 is arranged one on the upper side and the other on the lower side, and can grasp the seal portions Z by sandwiching the seal portions Z from above and below. This pair of grip fingers 81 each includes a finger body 81a and a grasp portion 81b. The finger bodies 81a can move (pivot) in the arrow f direction (FIG. 11), with fulcrums 82a provided on the hand 82 as the centers thereof.

The grasp portions 81b are mounted on the tip of the finger bodies 81a, and the surfaces 81b1 for grasping the seal portions Z take on a curved shape. Rubber and the like, for instance, having elasticity, is adopted for the grasp portions 81b. By doing so, it becomes easier to grasp the seal portions Z, and as a result, it can prevent the seal portions Z from falling off from between the upper and lower grasp portions 81 b after being grasped.

The hands 82 are supported on the arms 83, and are both equipped with the pair of grip fingers 81 (FIG. 4). The hands 82 can adjust the positions thereof relative to the arms 83. The arms 83 can move along the tiled guide rails 84.

### Positional Relationship with Respect to Brush Unit 7

On the both sides of the brush unit 7 are each of the grip fingers 81, and the hands 82 as well, for these grip fingers 81 (FIG. 7).

The grip fingers 81, one on each side, on both sides of the brush unit 7 grasps the seal portions Z longitudinally at the both sides of the brushes 76. Consequently, wrinkles on the portion of the seal portions Z between the two grip fingers 81 are undone by the brush unit 7.

### Operation of Grasp Unit 8

The grasp unit 8 holds the seal portions Z after the seal portions Z have been dewrinkled by the brush unit 7 at a position (grasp position) P1 near the terminal end portion of the drop conveyor 5. Details will be described using FIGS. 12 and 4.

FIG. 12 shows the seal portion Z, from a state of starting to be grasped (FIG. 12(a)), to a state of completely being grasped (FIG. 12(c)). More specifically, since the surfaces 81b1 of the grasp portions 81b take on a curved shape, the seal portion Z is grasped gradually from the edge portion side to the base portion side. By doing so, it is possible to prevent the seal portion Z from being wrinkled when the grasp unit 8 grasps the seal portion Z.

After that, the grasp unit 8 moves in the arrow d (FIG. 4) direction, more specifically, distant side (front side) of arrow b (FIG. 4), and to the direction slanting downwards (obliquely downwards). As a result, the bag X being grasped moves to the attaching unit 9, more specifically, to a position (attaching position) P2. This is for separating the grasp position P1 and the attaching position P2. By doing so, there is plenty of space for the attachment operation at the attaching position P2. Consequently, the attachment operation can be done easily, and as a result, a favorable state of attachment can be obtained easily.

When moving the bag X in the arrow d direction, the drop conveyor 5 moves to the arrow e (FIG. 4) direction, and tilts.

The grasp unit 8 described above does not hold the transverse side portion of the bag X, but holds the seal portion Z from the distal end of the seal portion Z of the bag X, adjacent to a location where it is to be attached to the tape T (FIGS. 11 and 12). Consequently, regardless of the dimension of the width of the seal portion Z, the grasp unit 8 is able to grasp the seal portion Z of the bag X precisely.

In addition, it is possible to arrange the grasp unit 8 in front of the bag Z being conveyed thereto. Furthermore, it is not necessary to move the grasp unit 8 in the width direction of the bag X. Consequently, the mechanism and operation of the grasp unit 8 is simplified.

Furthermore, by holding the seal portions Z of the bags X to be attached to the tape T, for example, the seal portions Z can be flattened even if the seal portions Z are bent, and as a result, bags X can be attached to the tape T in a favorable state.

In addition, since the grasp unit 8 holds the seal portion Z at the both sides of the attachment region R provided on the seal portion Z (FIG. 6), the attachment region R of the seal portion Z to be attached to the tape T can be flattened efficiently. Consequently, this further enhances the attachment of the bags X.

Since the grasp unit 8 holds the seal portion Z at the both sides of the brush unit (dewrinkler device) 7 for undoing the wrinkles on the seal portion Z (FIG. 7), the region of the seal portion Z on which wrinkles are undone by the brush unit 7 can be flattened efficiently. Consequently, this further enhances the attachment of the items X.

### Control of Strip Pack Apparatus 1

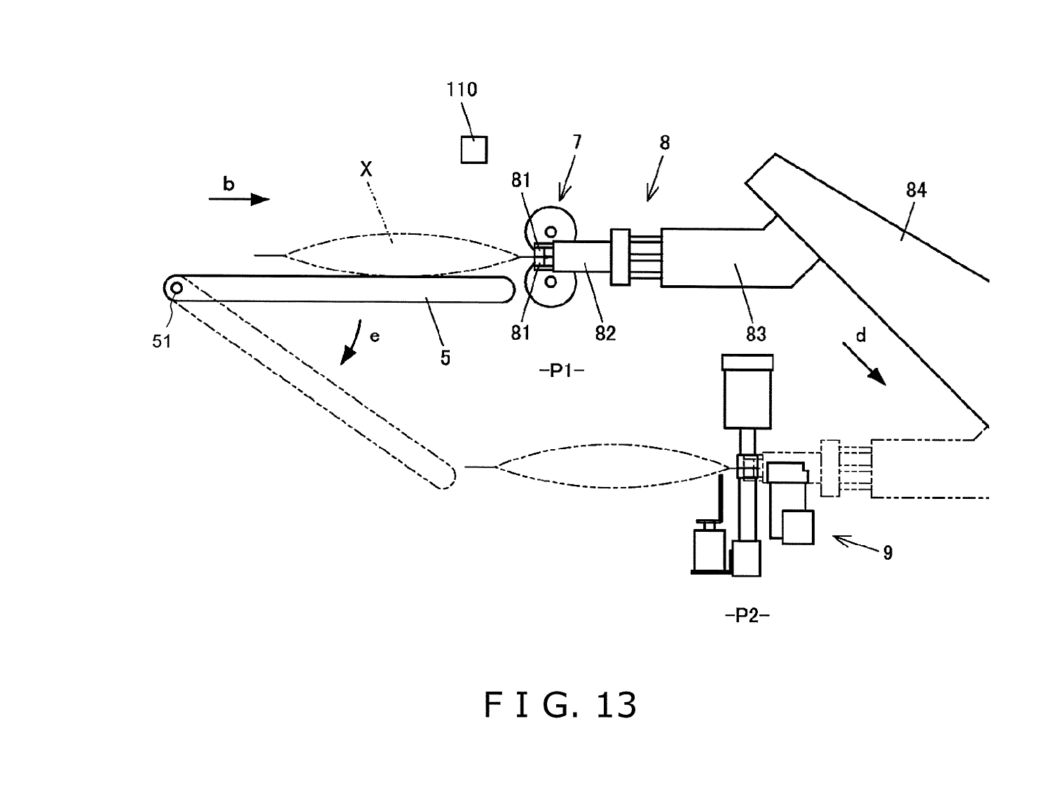

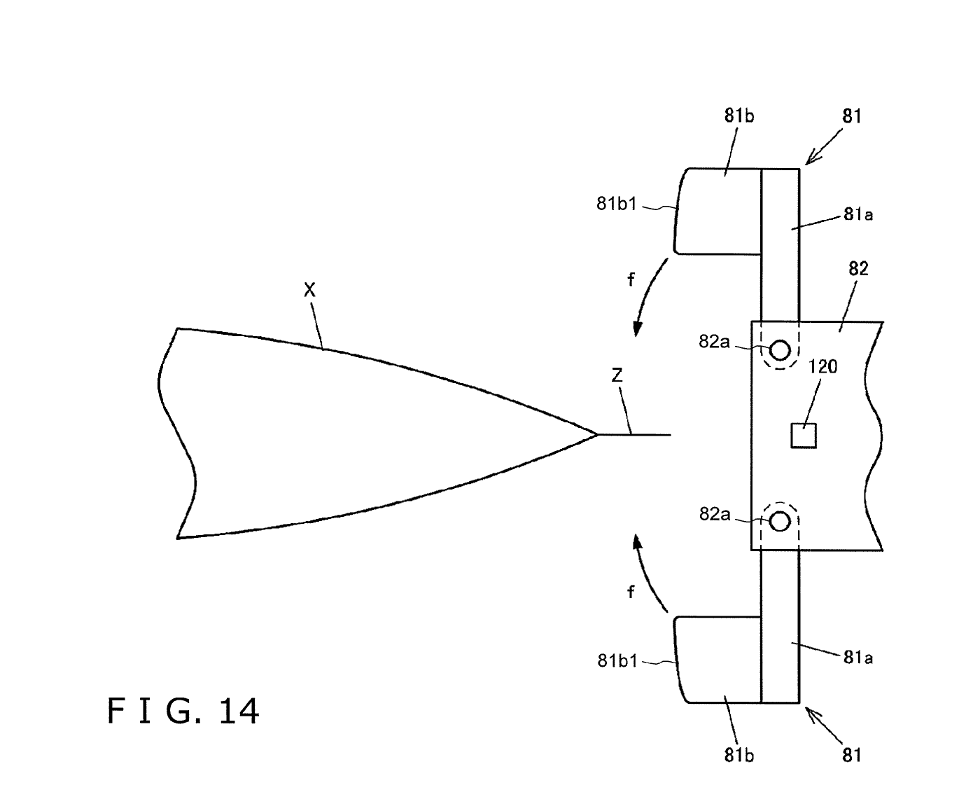

FIGS. 13 and 14 show the strip pack apparatus 1 having the above described grasp unit 8. This strip pack apparatus 1 further includes a bag position detection sensor 110 and a grip detection sensor 120.

The bag position detection sensor 110 is arranged on the terminal end portion of the drop conveyor 5 (FIG. 13), and detects whether or not a bag X is in the proper position on the drop conveyor 5 before the bag X is held by the grasp unit 8. Something that analyzes an image of an object on the drop conveyor 5 taken by a CCD camera and the like, for instance, can be adopted for this bag position detection sensor 110.

The grip detection sensor 120 is arranged on the hand 82 (FIG. 14), and detects when the seal portion Z of the bag X is held by the pair of grip fingers 81. Something that analyzes whether or not an object is being sandwiched between the grip fingers 81 by calculating the distance and the included angle between the grip fingers 81 when the pair of grip fingers 81 is closed, for instance, can be adopted for the grip detection sensor 120.

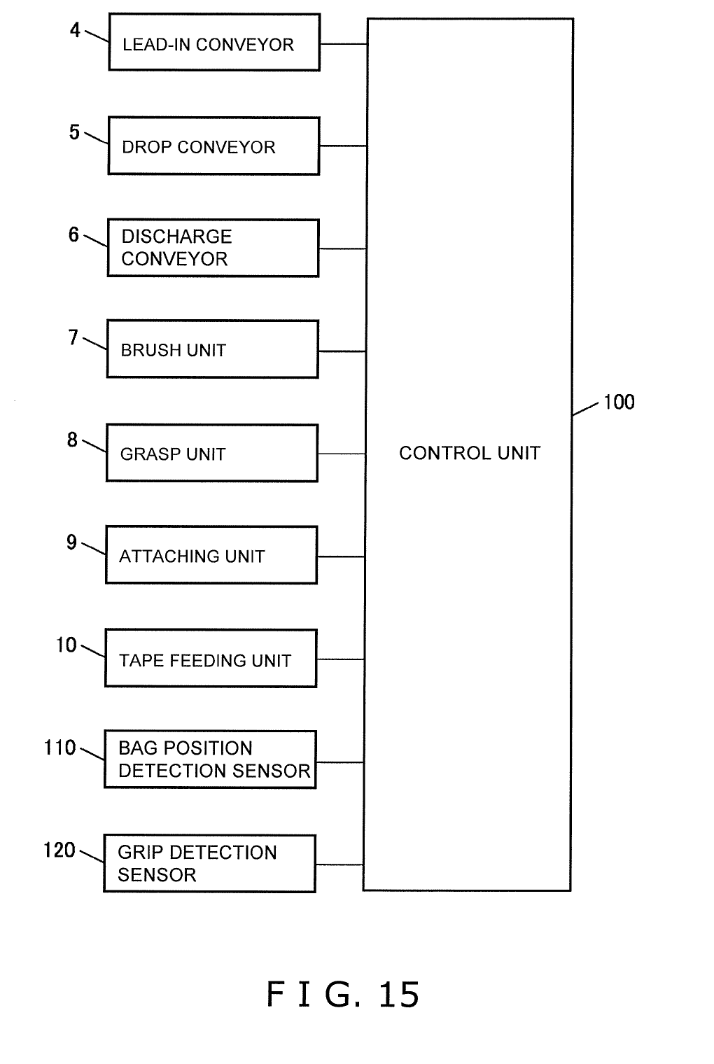

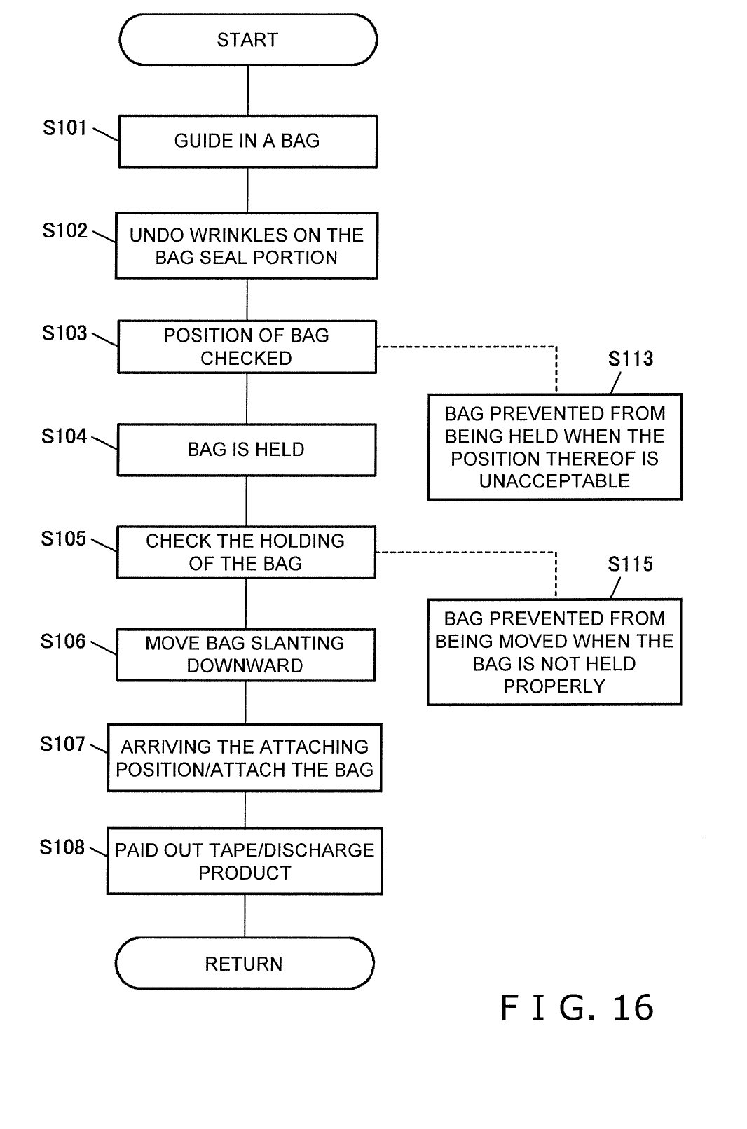

Next, the control of the strip pack apparatus 1 will be described. FIG. 15 is a block diagram showing the connection relationship between a control unit 100 of the strip pack apparatus 1 and each of the devices. FIG. 16 is a flowchart showing the control of the strip pack apparatus 1.

As shown in FIG. 15, the control unit 100 of the strip pack apparatus 1 is connected to each of the conveyors 4 to 6, each of the units 7 to 10, and each of the sensors 110 and 120, and is able to receive and send various signals. The control of the strip pack apparatus 1 through the control unit 100 will be described below using FIG. 16.

First, a bag X is guided in by the lead-in conveyor 4 to the grasp position P1 (Step S101), and dewrinkling of the seal portion Z is performed on this bag X by the brush unit 7 (Step S102). Then, the bag position detection sensor 110 judges whether or not the bag X is in an acceptable position (Step S103). When it is judged that the position is acceptable, the grasp unit 8 holds the bag X (Step S104). On the other hand, if it is judged that the position is unacceptable, the grasp unit 8 is prevented from holding the bag X (Step S113).

When the bag X is held (Step S104), the grip detection sensor 120 judges whether or not the bag X is being held properly (Step S105). When it is judged that the bag X is being held properly, the bag X is moved slanting downward on the front side of the conveying direction b (Step S 106). On the other hand, if it is judged that the bag X is not being held properly, the bag X is prevented from being moved (Step S115).

By doing so, for any reason, if the bag X is placed at an angle on the drop conveyor 5, or when the position thereof is off, the bag X can be prevented from being attached to the tape T. Consequently, this can prevent a defective product of a strip pack 1 from being manufactured.

When the bag X reaches the attaching position P2 having gone through step S106, the bag X is attached to the tape T by the attaching unit 9 (Step S107). Then, tape T is sent out by the tape feeding unit 10, and the strip pack SP, being the product, is discharged (Step S108).

According to the control of the strip pack apparatus 1 described above, whether or not the position of the item X is proper is detected by the bag position detection sensor 110 before it is being held by the grasp unit 8 (Step S103 in FIG. 16), and whether or not the item X judged to be in a proper position is held properly by the grasp unit 8 is detected (Step S105 in FIG. 16). Consequently, the bag X is attached to the tape T only when it is judged to be proper in both the detections, and thus, a plurality of bags X can be lined up visually pleasantly on the tape T. As a result, the likeliness of a strip pack SP (refer to FIG. 3(b)) being a non-defective product can be improved.

### Modification Example

The seal portion Z of a bag X may be held from the sides by the pair of grip fingers 81 shown in chained line in FIGS. 6 and 7. By doing so, portions near the portion dewrinkled by the brush unit 7 can be held, and also, the seal portion Z being held will not slip off easily from the pair of grip fingers 81.

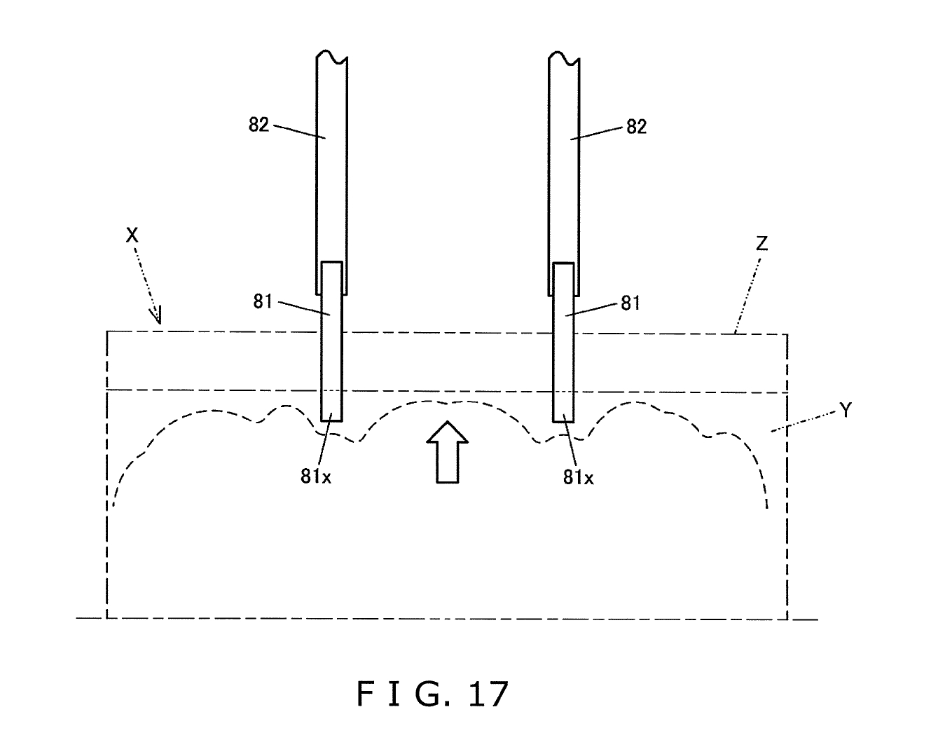

As it is illustrated in FIG. 17, extension portions 81x extending to the rear side in the conveying direction b from the pair of grip fingers 81 may be provided. By doing so, when the seal portion Z is held by the grasp unit 8, portions of the hollow portion Y can also be held. Consequently, even if the contents filled inside the hollow portion Y moves to the side of the seal portion Z due to inertia and the like, the seal portion Z can be prevented from being looped back or bent, due to a pressure and the like occurred when moving.

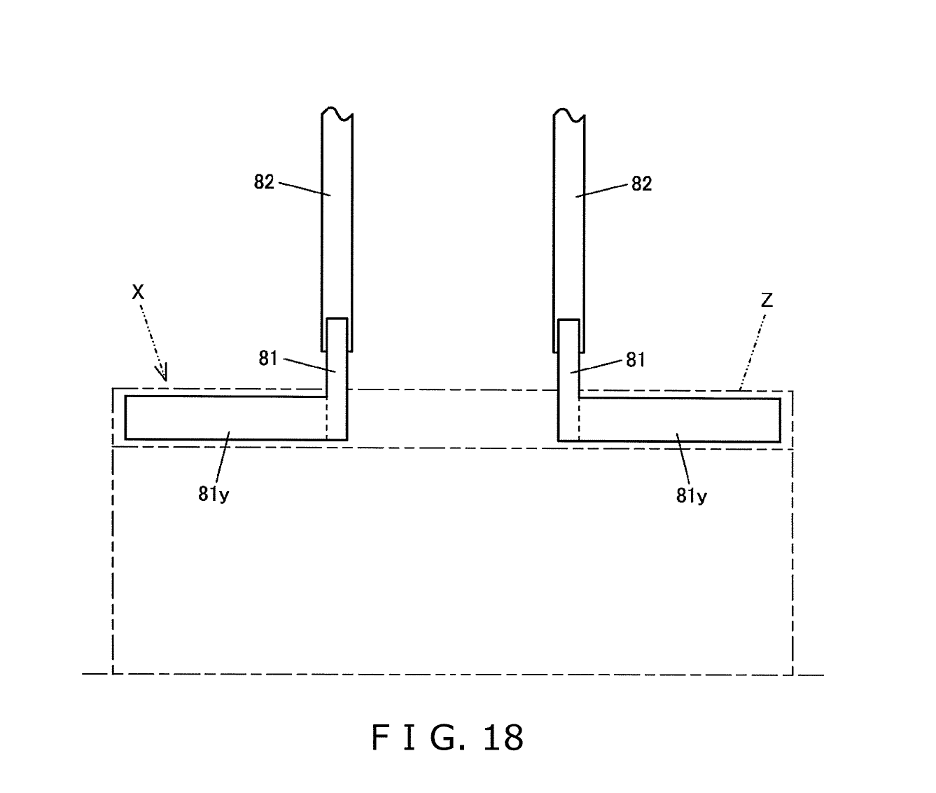

As illustrated in FIG. 18, extension portions 81y extending in the width direction from the pair of grip fingers 81 may be provided. By doing so, a wide range of the seal portion Z can be held, and as a result, the seal portion Z being held will not slip off easily from the pair of grip fingers 81.

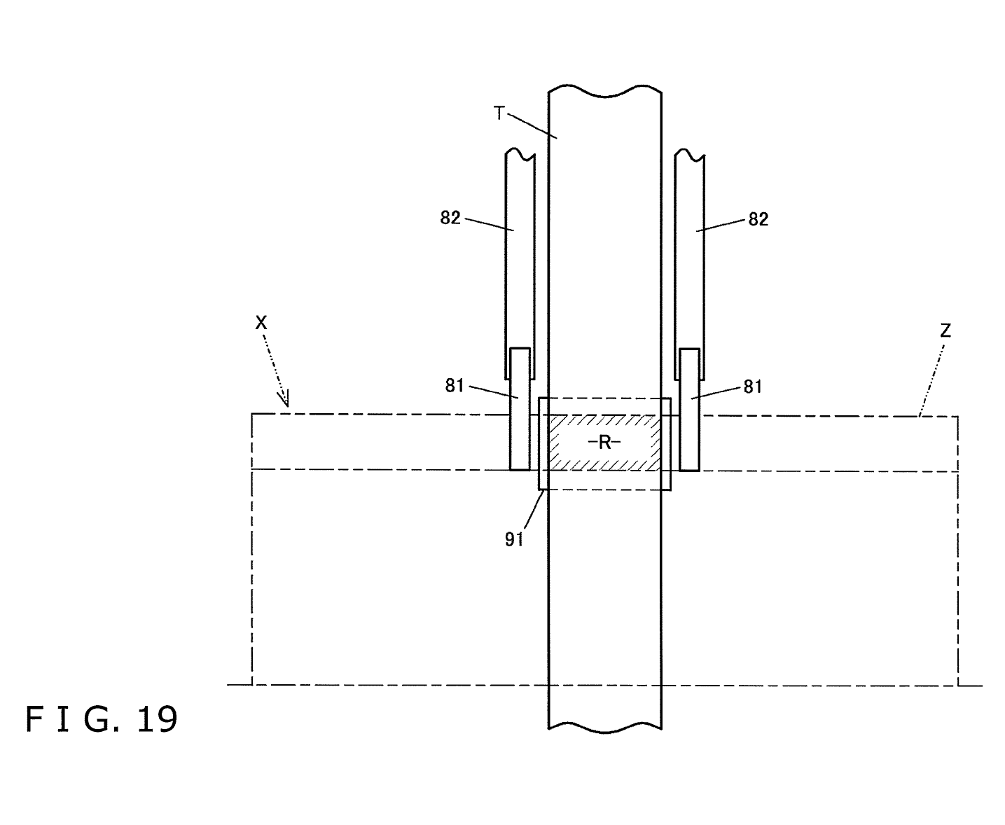

With the strip pack apparatus 1 not equipped with the brush unit 7, as illustrated in FIG. 19, the pair of grip fingers 81 can get closer to the attachment region R.

### D. Retracting Cylinder 70

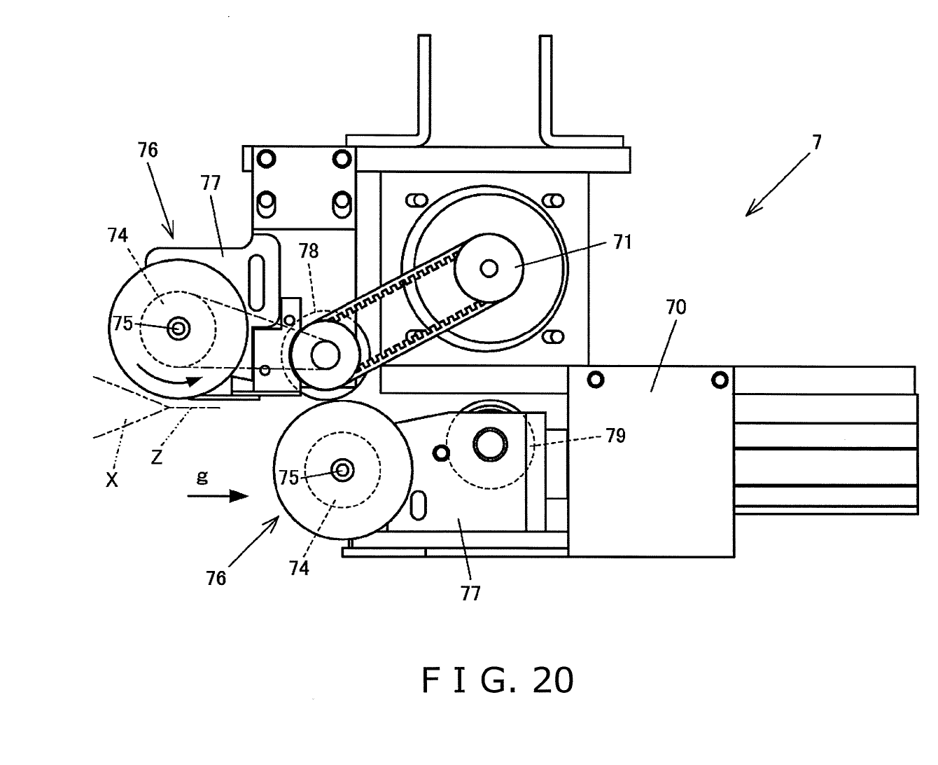

The retracting cylinder 70 (FIG. 9) has a rod, and this rod can be reciprocated along the arrow g direction. The rod is coupled with the lower supporting member 77 of the brush unit 7. The operation of the retracting cylinder 70 will be described below using FIG. 20.

### Operation of Retracting Cylinder 70

When the grasp unit 8 moves from the grasp position P1 in the arrow d (FIG. 4) direction to the attaching position P2, the retracting cylinder 70 moves the supporting member 77 coupled with the rod in the arrow g direction. That is, the lower supporting member 77 is evacuated or retracted to the arrow g direction. By doing so, the brush 76 supported on the lower supporting member 77 is also evacuated or retracted to the arrow g direction, that is, to the front side of the conveying direction b.

According to the above operation of the retracting cylinder 70, the bag X held by the grasp unit 8 can be moved smoothly from the grasp position P1 to the attaching position P2. That is, it is possible to prevent the bag X from interfering with the brush unit 7.

In addition, since it is only necessary to retract the lower portion of the brush unit 7 roughly horizontally and to the front side of the conveying direction b of the bag X, the configuration of the retracting cylinder 70 and the brush unit 7 will not become complicated. In addition, since only the lower portion of the brush unit 7 is retracted by the retracting cylinder 70, this is efficient compared to if the entire brush unit 7 is being retracted.

Furthermore, since the driven roller 79 supported on the lower supporting member 77 is also retracted to the arrow g direction, the driven roller 79 separates from the drive roller 78 (FIG. 20), and as a result, the rotation of the lower brush 76 stops. Consequently, when the bag X held by the grasp unit 8 moves to the arrow d direction, even if the bag X is touched by the lower brush 76, since the brush 76 is stopped, it is possible to prevent the dewrinkled seal portion Z from being wrinkled again.

### Control of Strip Pack Apparatus 1

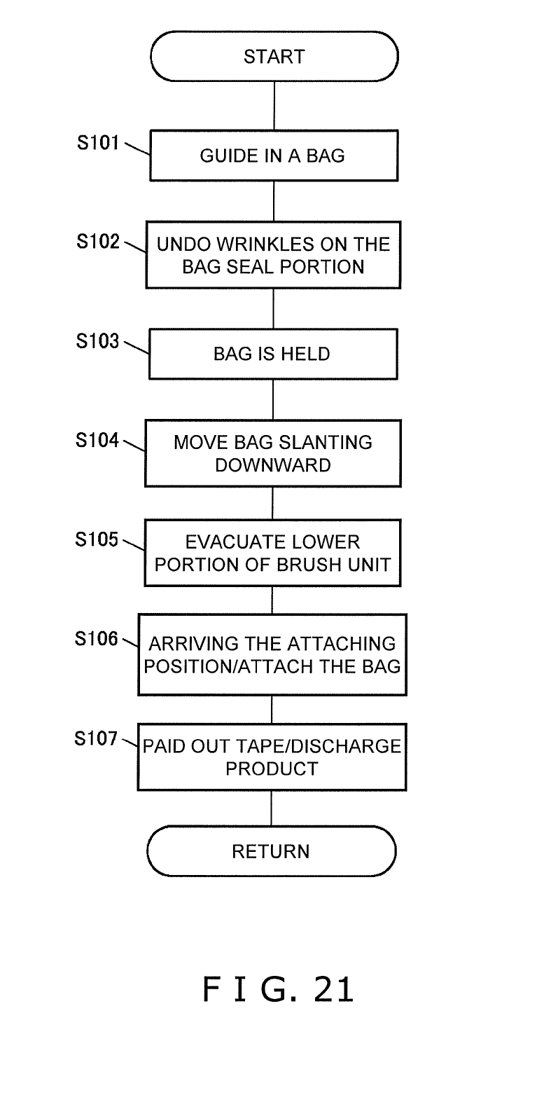

FIG. 21 is a flowchart showing the control of the strip pack apparatus 1 having the retracting cylinder 70. In addition, the retracting cylinder 70 is connected to the control unit 100 shown in FIG. 15.

First, the bag X is guided in by the lead-in conveyor 4 to the grasp position P1 (Step S101), and the seal portion Z of the bag X is dewrinkled by the brush unit 7 (Step S102). Then, the bag is held by the grasp unit 8 (Step S103).

After that, the bag X is moved slanting downward on the front side of the conveying direction b (Step S104). At this time, the lower brush 76 of the brush unit 7 is retracted to the front side of the conveying direction b by the retracting cylinder 70 (Step S105).

When the bag X reaches the attaching position P2, the bag X is attached to the tape T by the attaching unit 9 (Step S106). The tape T is then paid out by the tape feeding unit 10, and the strip pack SP, being the product, is discharged (Step S107).

### Modification Example

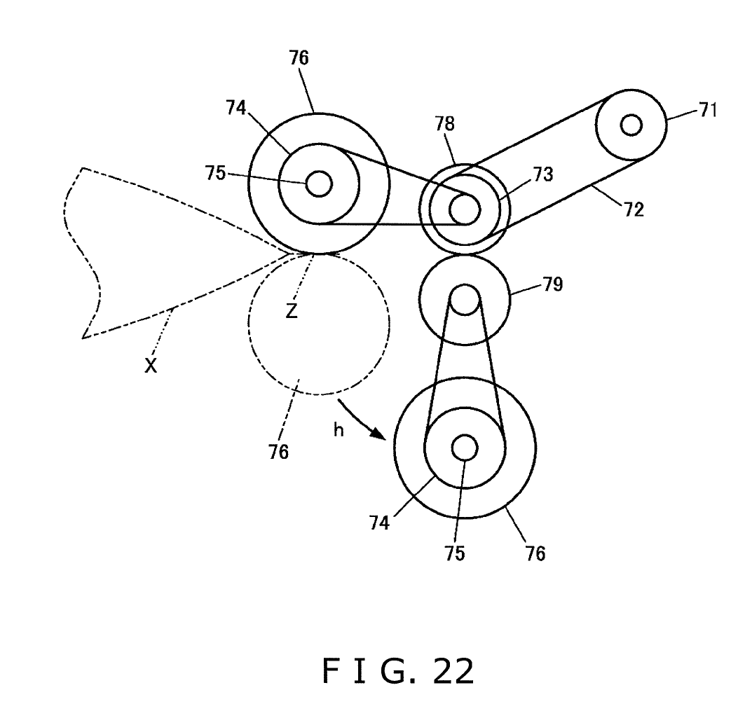

FIG. 22 shows a modification example of the brush unit 7. With the brush unit 7 shown in FIG. 15, the lower brush 76 can turn in the arrow h direction (downward).

With this brush unit 7, the lower brush 76 can be retracted to the front side of the conveying direction b by turning the lower brush 76 in the arrow h direction. In addition, since it is only necessary to turn the lower brush 76, the configuration of the brush unit 7 will not become complicated.

### E. Positioning Member 130

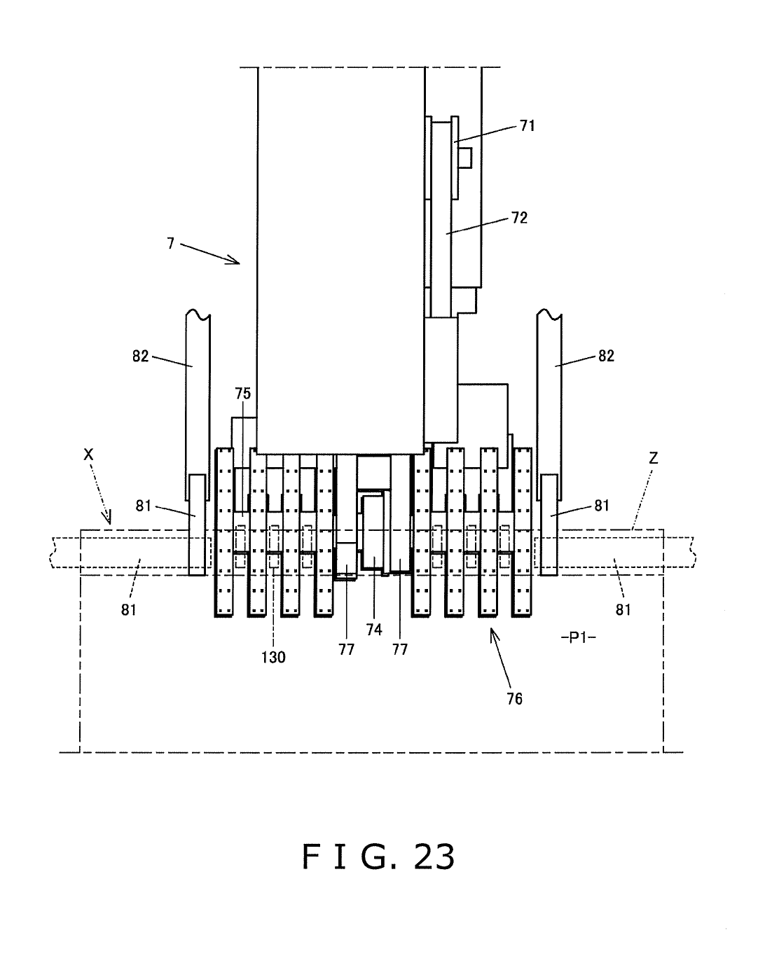

FIGS. 23 to 25 show the strip pack apparatus 1 having the positioning member 130. In addition, in all the figures, the area around the brush unit 7 is shown enlarged.

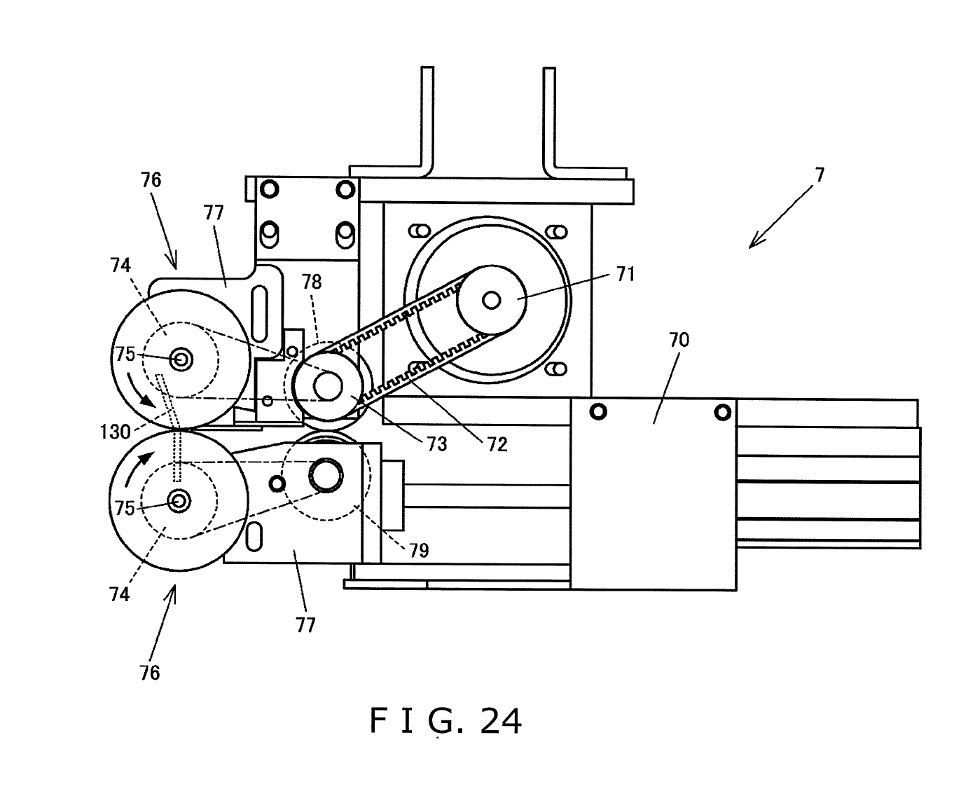

The positioning member 130 is a member that takes on a comb-like shape, and is supported on the lower supporting member 77. The rod of the retracting cylinder 70 is moved to the opposite direction from the arrow g direction, and when the drive roller 78 and the driven roller 79 are in the state of being in contact with each other (FIG. 24), the positioning member 130 meshes with the brushes 76. More specifically, the comb portion of the positioning member 130 is positioned between the plurality of the separated brushes that make up the brushes 76.

With the above described positioning member 130, when the seal portion Z of the bag X conveyed thereto by the drop conveyor 5 is inserted between the upper and the lower brushes 76, this seal portion Z is in contact with the positioning member 130. Consequently, the seal portion Z can be placed on the desired position, and as a result, the dewrinkling of the seal portion Z at the drop conveyor 5 can be performed efficiently.

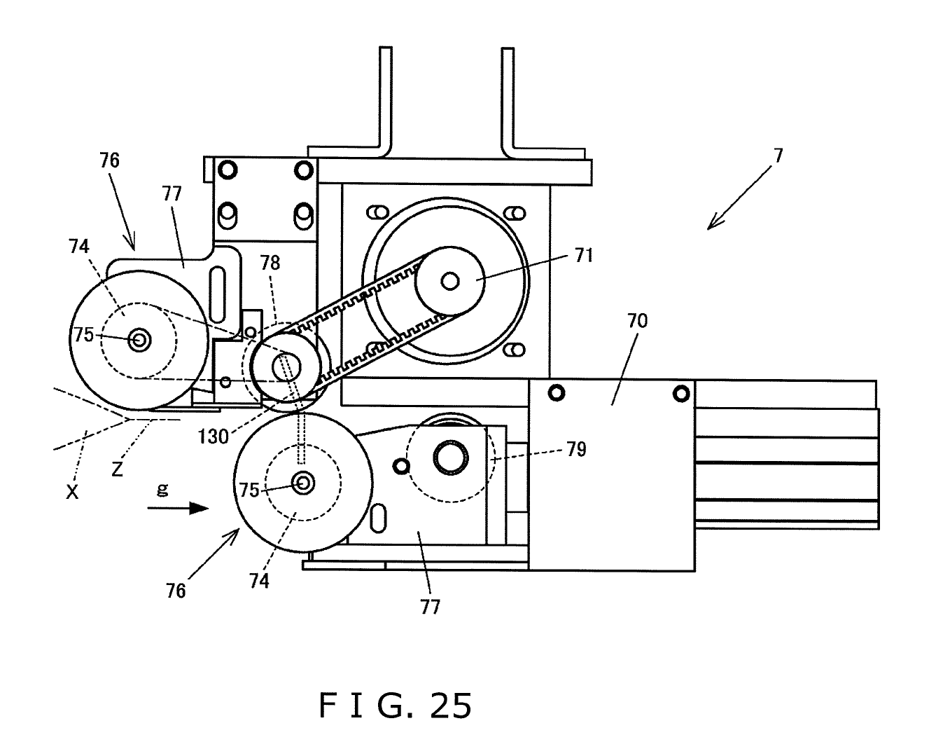

In addition, since the positioning member 130 is supported on the lower supporting member 77, by retracting the supporting member 77 to the arrow g direction through the retracting cylinder 70, the positioning member 130 can also be retracted to the arrow g direction (FIG. 25). Consequently, the bag X held by the grasp unit 8 can be moved smoothly from the grasp position P1 to the attaching position P2. That is, it is possible to prevent the bag X from interfering with the positioning member 130. In addition, the retraction of the positioning member 130 is performed in Step S105 shown in FIG. 21.

In FIGS. 23 to 25, since the positioning member 130 is supported on the lower supporting member 77, same as the brush 76, although it can be retracted to the arrow g direction through the same retracting cylinder 70, for example, the positioning member 130 may be retracted in the arrow g direction by a different cylinder from the retracting cylinder 70. However, as shown in FIGS. 23 to 25, it is more efficient to retract both the positioning member 130 and the brush 76 by the same retracting cylinder 70.

This invention was described in detail, but all of the situations described above are exemplifications that are not intended for limiting this invention. It is possible to think of other examples of modifications that are not illustrated, that do not deviate from the scope of this invention.

1. A grasper device used in a strip pack apparatus in which an item is attached to a backing sheet at an end portion of the item, the grasper device comprising:
a grasp portion configured and arranged to grasp the end portion of the item to be attached to the backing sheet from a distal end of the end portion of the item.

2. The grasper device according to claim 1, wherein
the grasp portion is configured and arranged to grasp the end portion on both transverse sides of an attachment region in the end portion to be attached to the backing sheet.

3. The grasper device according to claim 1, wherein
the grasp portion is configured and arranged to grasp the end portion at both sides of a dewrinkler device of the strip pack apparatus configured and arranged to dewrinkle the end portion of the item.

4. The grasper device according to claim 1, wherein
the grasp portion is configured and arranged to grasp the end portion of the item with the end portion including a part of a seal portion and a part of a hollow portion, beyond the seal portion, of a bag constituting the item.

5. The grasper device according to claim 1, wherein
the grasp portion is made of elastic material to grasp the end portion of the item.

6. A strip pack apparatus comprising:
the grasper device according to claim 1 to grasp the end portion of the item; and
an attaching unit configured and arranged to attach the end portion of the item to the backing sheet.

7. The strip pack apparatus according to claim 6, further comprising
a position detection unit configured and arranged to detect that the item prior to being grasped by the grasper device is in a prescribed position, and
a grasp detection unit configured and arranged to detect the item, being detected to be in the prescribed position by the position detection unit, is being grasped by the grasper device.

8. The strip pack apparatus according to claim 6, further comprising
a moving unit configured and arranged to move the item grasped by the grasper device to an attaching position at which the end portion of the item is attached to the backing sheet by the attaching unit.

9. A dewrinkler device used in a strip pack apparatus in which an item grasped by a grasper device is attached to a backing sheet at an end portion of the item, the dewrinkler device comprising:
a dewrinkling member configured and arranged to dewrinkle the end portion of the item that is grasped by the grasper device; and
a supporting member supporting the dewrinkling member at an intermediate portion of the dewrinkling member with respect to a direction parallel to the end portion of the item.

10. The dewrinkler device according to claim 9, wherein
the dewrinkling member is arranged on both surfaces of the end portion.

11. A strip pack apparatus comprising the dewrinkler device according to claim 9 to dewrinkle the end portion of the item.

12. The strip pack apparatus according to claim 11, further comprising
a grasper device configured and arranged to grasp the end portion of the item along a direction extending substantially parallel to the end portion of the item.

13. The strip pack apparatus according to claim 11, further comprising
a grasper device configured and arranged to grasp the end portion of the item from a distal end of the end portion of the item.

14. A strip pack apparatus for manufacturing a product with a plurality of items attached on a backing sheet, the strip pack apparatus comprising:
a conveying unit configured and arranged to convey the item generally in the horizontal direction;
a dewrinkling unit configured and arranged to dewrinkle an end portion on the front side in the conveying direction of the item conveyed by the conveying unit;
a moving unit configured and arranged to move the item, with the end portion dewrinkled by the dewrinkling unit, slanting downward on the front side in the conveying direction;
an attaching unit configured and arranged to attach the item moved by the moving unit to the backing sheet at the end portion; and
a retracting unit configured and arranged to retract the dewrinkling unit generally towards the front side in the conveying direction when the item is moved by the moving unit.

15. The strip pack apparatus according to claim 14, wherein
the dewrinkling unit includes an upper dewrinkling member configured and arranged to be positioned above the end portion of the item to dewrinkle an upper surface of the end portion, and a lower dewrinkling member configured and arranged to be positioned below the end portion of the item to dewrinkle an undersurface of the end portion, and
the retracting unit is configured and arranged to retract only the lower dewrinkling member.

16. The strip pack apparatus according to claim 15, wherein
the retracting unit is configured and arranged to move the lower dewrinkling member generally in the horizontal direction so as to retract the lower dewrinkling member towards the front side in the conveying direction.

17. The strip pack apparatus according to claim 15, wherein
the retracting unit is configured and arranged to turn the lower dewrinkling member downwardly so as to retract the lower dewrinkling member generally towards the front side in the conveying direction.

18. The strip pack apparatus according to claim 16, wherein
the upper dewrinkling member and the lower dewrinkling member are an upper brush and a lower brush for rotating from a base portion side to an edge portion side of the end portion of the item while in contact with the upper surface and the undersurface of the end portion,
the dewrinkling unit further includes a drive roller driven by a driving source to rotate the upper brush, and a driven roller driven by being in contact with the drive roller for rotating the lower brush, and
when the lower brush is moved generally in the horizontal direction by the retracting unit, the driven roller is separated from the drive roller.

19. The strip pack apparatus according to claim 18, wherein
the drive roller is made of metal, and the driven roller is made of resin.

20. A strip pack apparatus for manufacturing a product with a plurality of items attached to a backing sheet, the strip pack apparatus comprising:
a conveying unit configured and arranged to convey the item generally in the horizontal direction;
a positioning member configured and arranged to position the item by contacting with an end portion on the front side in the conveying direction of the item conveyed by the conveying unit;
a moving unit configured and arranged to move the item positioned by the positioning member slanting downward on the front side in the conveying direction;
an attaching unit configured and arranged to attach the item moved by the moving unit to the backing sheet at the end portion; and
a retracting unit configured and arranged to retract the positioning member generally towards the front side in the conveying direction when the item is moved by the moving unit.

21. The strip pack apparatus according to claim 20, further comprising
a dewrinkling unit configured and arranged to dewrinkle the end portion on the front side in the conveying direction of the item positioned by the positioning member,
the retracting unit being further configured to retract the dewrinkling unit generally towards the front side in the conveying direction when the item is moved by the moving unit.

22. The strip pack apparatus according to claim 21, wherein
the dewrinkling unit includes an upper dewrinkling member configured and arranged to be positioned above the end portion of the item to dewrinkle an upper surface of the end portion, and a lower dewrinkling member configured and arranged to be positioned below the end portion of the item to dewrinkle an undersurface of the end portion,
the positioning member is coupled to the lower dewrinkling member, and
the retracting unit is configured and arranged to retract the lower dewrinkling member and the positioning member.
